(19) United States
(12) Patent Application Publication
(10) Pub. No.: US 2006/0198960 A1
(43) Pub. Date: Sep. 7, 2006

(54) Process for making and using additive delivery laminate

(76) Inventors: Steven T. Calvert, Simpsonville, SC (US); David Herndon, Moore, SC (US); Hillary Crawford, Simpsonville, SC (US); Andrew Moehlenbrock, Simpsonville, SC (US); David R. Kyle, Moore, SC (US); Milissa Smith, Greer, SC (US); George Wofford, Duncan, SC (US); Dilip Boal, Greenville, SC (US); Mike Rosinski, Woodruff, SC (US); Blaine Childress, Inman, SC (US); Richard Bradshaw, Greer, SC (US); Joe Milton Bowen, Anderson, SC (US); James Douglas Wilson, Greeville, SC (US)

Correspondence Address: Rupert B. Hurley, Jr.;Sealed Air Corporation, P.O. Box 464, Duncan, SC, 29334, US

(21) Appl. No.: 11/187,801

(22) Filed: Jul. 22, 2005

Related U.S. Application Data
(60) Provisional application No. 60/590,826, filed on Jul. 22, 2004.

(51) Int. Cl. B05D 1/32; B65B 63/08; B05D 3/02; B26D 7/27; B05D 1/02; B67C 3/22; B05D 1/28

(52) U.S. Cl. 427/282; 427/372.2; 427/421.1; 427/428.01; 53/396; 53/428; 53/440; 53/127

(57) ABSTRACT

An additive delivery laminate, suitable for cooking a food product and transferring a colorant, flavorant, and/or odorant to a food product, has an additive delivery layer comprising a thermoplastic layer and additive granules containing a food additive. The laminate further comprises a substrate layer to which the additive delivery layer is bonded. The additive delivery layer is placed in contact with the food product to be packaged, with the granules thereafter dissolving and the additive being transferred to the food product. The additive can be transferred during cook-in or otherwise. Also disclosed is a process for preparing the additive delivery laminate and a process for preparing a packaged food product.

### CROSS-REFERENCE TO RELATED APPLICATION

This application claims priority from parent U.S. Ser. No. 60/590,826, filed 22 Jul. 2004, which is hereby incorporated, in its entirety, by reference thereto.

### FIELD OF THE INVENTION

The present invention relates generally to packaging, and more specifically to thermoplastic laminates, more particularly to methods for making and using packaging having an additive delivery layer thereon. Upon packaging and heating a food product, the additive is transferred from the additive delivery layer to the food product upon heating the food product.

### BACKGROUND OF THE INVENTION

The commercial food packaging industry has for many years carried out processes in which a food additive is used to modify a food product by imparting a desired color, flavor, or odor to the product. In the meat industry, this has included modification of a meat product during cooking of the meat, Typically, smoke flavor and color, and caramel coloring, having been used to modify the meat product.

There remains a need to improve the manner in which color, flavor, and odor food additives are combined with food products, and to improve the quality of the resulting modified food product. Problems experienced in the prior art include, among others, uneven distribution of the food additive in or on the food product, inability to transfer enough food additive to the food product, inadequate adhesion of the food additive to the food product upon removing the package from the food product, and poor appearance of the food product after transfer of the food additive to the food product. It would be desirable to provide a process which addresses one or more of these areas.

### SUMMARY OF THE INVENTION

As a first aspect, the invention is directed to a process for preparing a laminate by dispersing water soluble granules into an organic solvent/polymer solution to make an additive delivery slurry, depositing the additive delivery slurry onto a substrate, and evaporating the organic solvent from the additive delivery slurry. The water-soluble granules comprise at least one member selected from the group consisting of colorant, flavorant, and odorant. Evaporation of the organic solvent from the additive delivery results in the formation of an additive delivery laminate having an additive delivery layer and a substrate layer. The additive delivery layer comprises the water-soluble granules.

As a second aspect, the present invention is directed to a process for preparing an additive delivery laminate, comprising: (A) providing an additive delivery slurry comprising an organic solvent, a water-insoluble thermoplastic polymer dissolved in the organic solvent, and additive granules dispersed in the organic solvent; (B) applying a coating of the additive delivery slurry onto a substrate; and (C) evaporating the organic solvent from the additive delivery slurry to form an additive delivery layer on the substrate. The additive granules comprising at least one member selected from the group consisting of colorant, flavorant, and odorant.

As a third aspect, the present invention pertains to a process for imparting color, fragrance, and/or flavor to a food product, comprising (A) preparing an additive delivery laminate; (B) converting the additive delivery laminate into a packaging article so that the additive delivery coating is present on the inside surface of the packaging article; (C) packaging a food product in the packaging article; and (D) heating the food package so that the colorant and/or flavorant and/or odorant are transferred to the food product. The additive delivery laminate is prepared by (i) preparing an additive delivery slurry comprising an organic solvent, a water-insoluble thermoplastic polymer dissolved in the organic solvent, and additive granules dispersed in the organic solvent; (ii) applying a coating of the additive delivery slurry onto a substrate; and (iii) evaporating the organic solvent from the additive delivery slurry to form an additive delivery coating on the substrate. The additive granules comprise at least one member selected from the group consisting of colorant, flavorant, and odorant

As a fourth aspect, the present invention is directed to a process for preparing a cooked food product, comprising: (A) packaging a food product in a packaging article comprising an additive delivery laminate which is adhered to itself or another component of the packaging article, and (B) heating the packaged food product to a temperature of from 45° C. to 200°, so that at least a portion of the additive is delivered to the food product. The laminate comprises: (1) a substrate layer; and (2) an additive delivery layer comprising: (i) a thermoplastic polymer, and (ii) water-soluble granules comprising at least one member selected from the group consisting of colorant, flavorant, and odorant. The water-soluble granules form at least a portion of a surface of the additive layer which is opposite the substrate layer.

As s fifth aspect, the present invention pertains to a process for preparing a cooked food product, comprising: (A) packaging a food product in a packaging article comprising a laminate which is adhered to itself or another component of the packaging article; and (B) heating the packaged food product to a temperature of from 45 C to 200 C, so that at least a portion of the additive transfers to the food product. The laminate comprises, wherein the laminate comprises: (1) a substrate layer; and (2) an additive delivery layer comprising: (i) a thermoplastic polymer, and (ii) additive granules comprising at least one member selected from the group consisting of colorant, flavorant, and odorant; and (iii) a hydrogenated rosin. The additive granules form at least a portion of a surface of the additive layer which is opposite the substrate layer.

### BRIEF DESCRIPTION OF THE DRAWINGS

FIG. 1 illustrates a schematic view of a process for making a substrate film in accordance with the present invention.

FIG. 2 illustrates a schematic view of a process for coating a substrate film to make the additive delivery laminate of the invention, using a knife-over-roll gap coating process.

FIG. 3 illustrates a schematic view of a process for coating a substrate film to make the additive delivery laminate of the invention, using a gravure coating process.

FIG. 4 illustrates a schematic view of a process for coating a substrate film to make the additive delivery laminate of the invention, using a reverse roll coating process.

FIG. 5 illustrates a schematic view of a process for coating a substrate film to make the additive delivery laminate of the invention, using a meyer rod process.

FIG. 6 illustrates a schematic view of a process for coating a substrate film to make the additive delivery laminate of the invention, using an extrusion coating process.

FIG. 7 illustrates a schematic view of a process for coating a substrate film to make the additive delivery laminate of the invention, using a curtain coating process.

FIG. 8 illustrates a schematic view of a process for coating a substrate film to make the additive delivery laminate of the invention, using an air knife coating process.

FIG. 9 illustrates a schematic view of a process for coating a substrate film to make the additive delivery laminate of the invention, using a rotary screen printing process.

### DETAILED DESCRIPTION OF THE INVENTION

The phrase “additive delivery layer” refers to a layer of the laminate which contains the water-insoluble thermoplastic polymer and additive-containing granules. In operation, the granules in the additive delivery layer transfer to the food product. Preferably, the additive delivery layer is prepared by combining the thermoplastic polymer, a polymer toughening agent, an organic solvent, and the additive granules, with the thermoplastic polymer and the polymer toughening agent being dissolved in the organic solvent, with the additive granules then being stirred into the solution. The resulting slurry is then deposited onto a substrate (which can, for example, be a film, either monolayer or multilayer), and the solvent evaporated, leaving the additive delivery coating affixed onto the substrate (i.e., bonded to the substrate), resulting in the additive delivery laminate. Upon evaporation of the solvent, the additive delivery layer can be present in an amount within the range of from about 5 to about 50 grams per square meter; or from about 10 to about 30 grams per square meter; or from about 10 to about 20 grams per square meter, or from about 20 to about 30 grams per square meter.

While the thermoplastic polymer of the additive delivery layer can optionally contain one or more water-soluble thermoplastic polymers (e.g., one or more polymers set forth in an optional “overcoat layer”, described below), the thermoplastic polymer of the additive delivery layer comprises at least one water-insoluble polymer. The water-insoluble thermoplastic polymer can made up 100% of the polymer of the additive delivery layer. If a blend of water-soluble polymer and water-insoluble thermoplastic polymer is present in the additive delivery layer, preferably the amount of water-soluble polymer is less than 50 percent, based on total weight of the water-insoluble thermoplastic polymer in the additive delivery layer, for example within a range of from about 1 to about 40 percent, or within from about 1 to 20 percent, or within from about 1 to about 10 percent, based on total weight of the water-insoluble thermoplastic polymer in the additive delivery layer.

Water-insoluble thermoplastic polymers include styrene-butadiene rubber, isobutylene/isoprene copolymer (e.g., butyl rubber), crosslinked butyl rubber, polyisoprene, polyisobutylene, polybutylene, styrene/isobutylene copolymer, ethylene/vinyl acetate copolymer, polybutadiene, ethylene/cyclo-olefin copolymer, polyvinyl acetate, cellulose triacetate, natural rubber, chicle, and balata rubber.

Polyisobutylene and crosslinked butyl rubber are preferred water-insoluble thermoplastic polymers for use in the additive delivery layer. Vistanex® MM L 80 polyisobutylene, Vistanex® MM L 100 polyisobutylene, Vistanex® MM L 120 polyisobutylene, Vistanex® MM L 140 polyisobutylene, and Kalar® 5263 crosslinked butyl rubber are suitable for use in the additive delivery layer. The polyisobutylene can have an intrinsic viscosity of from about 1 deciliter/gram to about 5 deciliters/gram, or from about 2 deciliters/gram to about 4.5 deciliters/gram, or from about 3 deciliters/gram to about 4 deciliters/gram.

As used herein, the phrase “polymer toughening agent” refers to an optional component which, when blended with the water-insoluble thermoplastic polymer, results in a blend which is tougher than the thermoplastic polymer in the absence of the toughening agent. The polymer toughening agent may produce a blend having higher modulus and/or higher cohesive strength and/or higher adhesive strength than the thermoplastic polymer in the absence of the toughening agent. The polymer toughening agent may be selected to produce a blend having a higher glass transition temperature (i.e., T_{g}) than the thermoplastic polymer without the toughening agent. One or more of various kinds of polymer toughening agents may be used in the laminate of the present invention.

Tackifiers can serve as polymer toughening agents in the additive delivery layer. A tackifier is a substance which when blended with the thermoplastic polymer produces a blend having a higher initial tack than the thermoplastic polymer in the absence of the toughening agent, and/or a greater tack range than possessed by the thermoplastic polymer in the absence of the polymer toughening agent. Tackifiers include terpene resin, polyterpene resin, rosin, and petroleum hydrocarbons. Exemplary of petroleum hydrocarbons are hydrocarbon resins, aliphatic resins, aromatic resins, hydrogenated hydrocarbon resins (both fully hydrogenated and partially hydrogenated), liquid resins (such as aromatic C9 type liquid resin), and mixed resins such as aliphatic/aromatic C5/C9 mixed feedstock resins.

Rosin includes rosin acids and rosin esters. Rosins are naturally occurring, are derived from pine trees, and contain unsaturation in the natural state. The unsaturation imparts instability to heat and oxidation. Hydrogenation renders rosins more stable to heat and oxidation. Rosins useful in the invention can be partially hydrogenated or fully hydrogenated. Examples of rosin include gum rosin (i.e., the pine gum harvested from living pine trees), wood rosin (derived from the heartwood of pine tree stumps), tall oil rosin (obtained by distillation of crude tall oil, which is a by-product of the pulping process), and rosin derivatives (such as rosin esters, including metallic salts of rosin esters). Rosin ester, hydrogenated rosin and partially hydrogenated wood rosin (particularly hydrogenated or partially hydrogenated wood rosin) are preferred tackifiers for the laminate of the present invention. Partially-hydrogenated and non-hydrogenated rosin can also be used as polymer toughening agents. However, hydrogenated rosins have greater heat stability than non-hydrogenated rosins.

Preferred rosins for use in the present invention include Foral® AX hydrogenated rosin, Foral® DX hydrogenated rosin, and Endere® S hydrogenated rosin ester.

Minerals (both inorganic and organic) can also server as polymer toughening agents in the additive delivery laminate. Both naturally-occurring minerals, processed minerals (e.g., purified minerals), and synthetic minerals are useful as polymer toughening agents in the laminate of the present invention. Calcium oxide can serve as a polymer toughening agent and/or release agent, as it has been found to reduce “legs”, i.e., to reduce the level of adhesion (and the level of transfer) of the water-insoluble polymer to the cooked food product upon separating the laminate from the food product after cooking. Pentaerythritol (i.e., tetramethylolmethane) and amber may also be used as polymer toughening agents. Silica (including fumed silica and amorphous silica), clay, talc, mica, and kaolin can serve as polymer toughening agents. The toughening agent can be present in the additive delivery layer in an amount of from about 0.1 to 30 weight percent, based on the weight of the thermoplastic polymer; or in an amount of from about 0.3 to 10 weight percent; or in an amount of from about 0.5 to 5 weight percent, based on the weight of the thermoplastic polymer.

The additive delivery layer may optionally further include one or more processing aids. Exemplary processing aids include substances which: (a) improve release of the additive from the additive delivery coating to the food product during heating, cooking, or reheating, (b) reduce adhesion of exposed surface of the additive delivery layer to the other outer surface of the laminate in the event that the laminate is wound into a roll for storage, and (c) improve the coefficient of friction (prevent blocking) of the coated laminate during manufacture, storage, and use of the laminate.

Processing aids include but not limited to, wax (including petroleum wax, paraffin, edible wax, bees wax, microcrystalline wax, polyolefin wax, amide wax, and oxidized polyethylene), various oils (including silicone oil, mineral oil, vegetable oil, lard), edible surfactant, and anti-fog agent, starch, and cellulose based polymers. The application of starch powder to the surface of the additive delivery layer can serve as an antiblocking agent, and can also serve to minimize the formation of legs.

Polymer toughening agents and processing aids can reduce undesired adhesion of the polymer to the food product when the laminate is stripped from the food product after transfer of the additive(s) to the food product. A polymer which adheres to the food product during stripping can exhibit “adhesive legs” during peeling of the laminate from the cooked food.

Adhesive legs are portions of an adhesive layer which strongly adhere to the adherend (e.g., the cooked food product). During separation of the adhesive layer (e.g., the additive delivery layer) from an object to which the adhesive is adhered, portions of the adhesive layer may adhere so strongly that they cause the adhesive material to stretch out to form visibly apparent connecting strands called “legs”. Adhesive legs are undesirable as they are present only if the polymer is adhering to the food. Legs are indicative of two potential undesirable consequences of adhesion of polymer to food product. The first undesirable consequence is transfer of pieces of polymer to the cooked food product. The second undesirable consequence is pulling pieces of food product off onto the laminate as it is being peeled from the cooked food product (e.g., “meat pull-off”). It is desirable for there to be few or no legs, no meat pull-off, and no transfer of polymer to meat product during stripping of the laminate from the cooked meat product.

Organic solvents useful in making the coating blend/solution include volatile hydrocarbon fluids selected from the group consisting of C₅ to C₁₂ alkanes and alkenes, aliphatic alcohols selected from the group consisting of C₃ to C₆ alcohols, ketones selected from the group consisting of C₃ to C₅ aliphatic ketones, and C₃ to C₁₂ organic esters. Pentane, hexane, heptane, octane, and iso-octane are suitable solvents. Optionally, the additive delivery laminate can further comprise an overcoat layer, i.e., a layer applied over the additive delivery layer. The overcoat layer should be water-soluble, and preferably comprises at least one member selected from the group consisting of polysaccharide and protein. More particularly, the overcoat layer comprises at least one member selected from the group consisting of alginate, cellulosic polymer, methyl cellulose, hydroxypropyl starch, hydroxypropylmethyl starch, hydroxymethyl cellulose, hydroxypropyl cellulose, hydroxypropylmethyl cellulose, carboxymethyl cellulose, cellulose esterified with 1-octenyl succinic anhydride, polyvinylalcohol, chitin, and chitosan, gliadin, glutenin, globulin, albumin (especially in the form of gluten), prolamin (especially corn zein), thrombin, pectin, carageenan, konjac flour-glucomannin, fibrinogen, milk protein, polysaccharide, casein (especially casein milk protein), soy protein, whey protein (especially whey milk protein), and wheat protein. The overcoating layer is optionally applied to assist in “clean” separation of the additive delivery coating from the food during the step of stripping away the laminate following heat processing.

As used herein, the term “substrate”, and the phrase “substrate layer” refer to the portion of the additive delivery laminate which supports the additive delivery layer. Although the substrate or substrate layer can be any article to which the additive delivery layer can be adhered, a preferred additive delivery layer is a thermoplastic article. A flexible film is a preferred article. The film can be a monolayer film or a multilayer film. Preferably, the substrate can be heat sealed by bringing uncoated portions of the heat seal layer together under heat and pressure to form a heat seal.

Preferably, the substrate comprises at least one member selected from the group consisting of polyolefin, polyethylene, ethylene/alpha-olefin copolymer, polypropylene, propylene/alpha-olefin copolymer, ethylene/vinyl acetate copolymer, ethylene/unsaturated ester copolymer, ethylene/alpha, beta-unsaturated carboxylic acid, ethylene/alpha, beta-unsaturated carboxylic acid anhydride, metal base neutralized salt of ethylene/alpha, beta-unsaturated carboxylic acid, ethylene/cyclo-olefin copolymer, ethylene/vinyl alcohol copolymer, polyamide, co-polyamide, polyester, co-polyester, polystyrene, and polyvinylchloride.

Film substrates onto which the additive delivery layer is applied may include one or more additional layers, depending on the properties required of the film. Preferred substrates are multilayer films, designed to achieve slip, modulus, oxygen barrier, and heat sealability. Polymers useful in making the first layer of a multilayer substrate film include polyolefin, vinylidene chloride copolymer (including vinylidene chloride/vinyl chloride/methyl acrylate copolymer), ethylene homopolymer and copolymer (particularly ethylene/alpha-olefin copolymer), propylene homopolymer, polybutene, butene/alpha-olefin copolymers, ethylene/unsaturated ester copolymer (particularly ethylene/vinyl acetate copolymer), ethylene/unsaturated acid copolymer (including ethylene/acrylic acid copolymer), ethylene/vinyl alcohol copolymer, polyamide, co-polyamide, polyester, co-polyester, and ionomer.

Heat sealable substrate layers may include high density polyethylene (HDPE), high pressure low density polyethylene (LDPE), ethylene/alpha-olefin copolymers (LLDPE and VLDPE), single-site catalyzed ethylene/alpha-olefin copolymers (linear homogeneous and long chain branched homogeneous ethylene/C₃-C10 alpha-olefin copolymers), interpenetrating network polymers (IPNs), substantially spherical homogeneous polyolefins (SSHPEs), polypropylene, polybutylene, butene/alpha-olefin copolymers, propylene/ethylene copolymer, and/or propylene/hexene/butene terpolymer. Additional film layers may be included, i.e., in addition to the seal layer. For example, an O₂-barrier layer (e.g., ethylene/vinyl alcohol copolymer, vinylidene chloride/methyl acrylate copolymer, and/or vinylidene chloride/vinyl chloride copolymer) may be utilized behind the seal layer of the substrate. Multilayer substrate films useful in practicing the invention include for example a first substrate layer of LLDPE, a second blend layer of 85% EVA and 15% HDPE, a third tie layer of maleic anhydride grafted-LLDPE, a fourth layer of ethylene/vinyl alcohol copolymer, a fifth blend layer of 50% nylon 6 and 50% 6/12 copolyamide, a sixth tie layer of maleic anhydride grafted-LLDPE, a seventh blend layer of 85% EVA and 15% HDPE, and an eighth outer layer of LLDPE. In such an example, layers 2-8 provide the substrate film with oxygen barrier and strength properties in addition to the heat seal property of the first substrate layer.

As used herein, the term “colorant” refers to a substance which imparts color to a product which otherwise would have a different color. Colorants include the various FD&C approves colorants, together with various other colorants. Preferably, the colorant comprises at least one member selected from the group consisting of caramel, maltose, beet powder, spice, soy granules, iron oxide, grape color extract, and carotene.

As used herein, the term “flavorant” refers to a substance that affects the sense of taste, and is synonymous with the noun “flavor”, and includes particulate flavorant additives that modify the flavor of a food composition. Flavorants include, but are not limited to, spices (dehydrated garlic, mustard, herbs), seasoning agents (honey mustard, cumin, paprika, chili, lemon, ginger, coriander, barbecue, dehydrated soy), baked, grilled (particularly chargrill flavorant), or roasted flavor components, fried flavorant (particularly dry fried flavorant), turkey pan drippings flavorant, dehydrated honey, dehydrated vegetable flavorants (tomato, onion, jalapeno, cayenne, chipotle chile, black pepper, habaneros), sea salt, and smoke flavorant (hickory, applewood, or mesquite smoke), and encapsulated smoke oil. Flavorants may be obtained from suppliers such as Gold Coast, Red Arrow, or Master Taste.

As used herein, the term “odorant” refers to a substance perceptible to the sense of smell, i.e., a scent. Preferred odorants include those which emit a pleasant aroma (such as a fragrance), or a savory aroma. Odorants include powdered smoke,

As used herein, the term “granule”, “granular”, or “granular agent”, comprises agglomerates as well as single particles. Granules can have a maximum dimension of from about 10 to about 500 microns, such as within a range of from about 15 to about 300 microns, or from about 50 to about 250 microns, or from about 70 to about 200 microns, or from about 75 to about 150 microns. Those of skill in the art appreciate that flavor particles may be useful in larger or smaller sizes, for instance cracked pepper can be larger than 500 micron. Granules as used herein include fine additive particles such as powders. Granules are usually solid, but may include liquid, e.g., the granules can include microencapsulated liquids, such as encapsulated smoke oil. Depending upon the process utilized for preparing the laminate, it may be advantageous to classify the additive granules, e.g., it may be advantageous to utilize granules having a maximum dimension of up to 75 microns, or a maximum dimension of up to 150 microns. Screening and air classification, among other processes, can be employed to classify the granules.

The additive granules can be present at relatively high loading levels, based on the total weight of the additive delivery layer. For example, the additive granules can make up from about 10 to about 90 weight percent of the total weight of the additive delivery layer. Alternatively, the additive granules can make up from about 25 to about 85 weight percent of the additive delivery layer, or from about 50 to about 85 weight percent of the total weight of the additive delivery layer.

The granules may form a portion of the outer surface of the additive delivery layer. The outer surface of the additive delivery layer is the surface of the additive-delivery layer which is not adhered to the substrate, i.e., the surface of the additive delivery layer which is oriented away from the substrate.

At least some of the granules may be adhered directly to the surface of the thermoplastic polymer, or attached to the thermoplastic polymer with an adhesive. At least some of the granules may form at least a portion of an outer surface of the additive layer. At least some of the granules may be partially coated or fully coated with the thermoplastic polymer. At least some of the granules may be partially or fully embedded within the additive delivery layer.

While the term “coated” is used herein with respect to granules no portion of which forms an outer surface of the additive delivery layer, the phrase “partially coated” is used with reference to granules a portion of which is coated and a portion of which forms a portion of the outer surface of the additive delivery layer.

Preferably, the granules extend above that surface of the thermoplastic polymer of the additive delivery layer which is opposite the substrate. While some of the granules may be adhered or embedded to the outer surface of the thermoplastic polymer of the additive delivery layer, other granules may be embedded underneath the outer surface(s) of the thermoplastic polymer of the additive delivery layer. A fully embedded granule which is water-soluble will dissolve from within the additive delivery layer if the water can reach the granule. It may require the dissolution of part or all of an adjacent granule in order for the water to reach a fully embedded granule. A granule which is completely surrounded by the thermoplastic polymer may not dissolve if the thermoplastic polymer does not allow water to reach the embedded granule. Nevertheless, many if not most or even all of the granules will dissolve if a high loading of granules is present in the additive delivery layer.

The color, aroma, and flavor granules as used herein refer to additives that modify the flavor, aroma, and color of a food composition, including but not limited to spices (such as dehydrated garlic, onion, mustard, herbs), seasoning agents (such as dehydrated honey, dehydrated soy sauce, cumin, chili, curry powder, dehydrated lemon, ginger, coriander), flavor concentrates (such as barbecue, grilled, baked, roasted flavor), dehydrated vegetable flavors (such as tomato, jalapeno, cayenne, chipotle, paprika habaneros), sea salt, and smoke flavor concentrates (such as glycoaldehyde, 2,6-dimethoxyphenol, guaiacol, or dehydrated hickory, applewood, and mesquite smoke), caramel, maltose, maltodextrin, beet powder, iron oxide, grape color extract, and carotene. Suppliers of color and flavor granules include vendors such as Gold Coast, Red Arrow, and Master Taste.

Powdered caramel is among the preferred additives for use in the present invention. Caramel 602, Caramel 603, Caramel 608, Caramel 622, Caramel 624, Caramel 625, Caramel 900 are among the preferred powdered caramels for use in the present invention.

The polymer components used to fabricate multilayer films according to the present invention may also contain appropriate amounts of other additives normally included in such compositions. These include slip agents such as talc, antioxidants, fillers, pigments and dyes, radiation stabilizers, antistatic agents, elastomers, and the like additives, as known to those of skill in the art of packaging films.

Although the substrate need not be crosslinked, in at least one embodiment, one or more layers of the substrate are crosslinked. Crosslinking may be accomplished by conventional methods including irradiation and the addition of chemical crosslinking agents, as for instance agents initiating free radical reactions when heated or exposed to actinic radiation. In irradiation crosslinking, the laminate is subjected to an energetic radiation treatment, such as corona discharge, plasma, flame, ultraviolet, X-ray, gamma ray, beta ray, and high energy electron treatment, which may alter the surface of the film and/or induce cross-linking between molecules of the irradiated material. The irradiation of polymeric films is disclosed in U.S. Pat. No. 4,064,296, to BORNSTEIN, et. al., which is hereby incorporated in its entirety, by reference thereto. BORNSTEIN, et. al. discloses the use of ionizing radiation for crosslinking polymer present in the film.

Radiation dosages are referred to herein in terms of the radiation unit “RAD”, with one million RADS, also known as a megarad, being designated as “MR”, or, in terms of the radiation unit kiloGray (kGy), with 10 kiloGray representing 1 MR, as is known to those of skill in the art. To produce crosslinking, the polymer is subjected to a suitable radiation dosage of high energy electrons, preferably using an electron accelerator, with a dosage level being determined by standard dosimetry methods. A suitable radiation dosage of high energy electrons is in the range of up to about 16-166 kGy, more preferably about 30-139 kGy, and still more preferably, 50-100 kGy. Preferably, irradiation is carried out by an electron accelerator and the dosage level is determined by standard dosimetry methods. The radiation is not limited to electrons from an accelerator since any ionizing radiation may be used. A preferred amount of radiation is dependent upon the laminate and its end use.

The substrate can also be corona treated. As used herein, the phrases “corona treatment” refers to subjecting the surfaces of thermoplastic materials, such as polyolefins, to corona discharge, i.e., the ionization of a gas such as air in close proximity to a film surface, the ionization initiated by a high voltage passed through a nearby electrode, and causing oxidation and other changes to the film surface, such as surface roughness.

A relatively high loading of water soluble granules in thermoplastic polymer, for example in an amount within the range of from about 20% to about 900% by weight, based on weight of thermoplastic polymer (or from about 50% to 500%, or from about 150% to 350%), is preferably prepared by first dissolving the thermoplastic polymer in an organic solvent, and thereafter adding the granules to the solution to make a slurry comprising the additive granules dispersed in the solution of the thermoplastic water insoluble polymer. This slurry, when applied to the substrate followed by evaporation of the organic solvent, produces a coating on the substrate which becomes the additive delivery layer of the resulting laminate. The evaporation of the organic solvent results in a continuous matrix of the thermoplastic polymer, in which some of the additive granules are embedded below the surface of the thermoplastic polymer, while other additive granules are adhered to the surface of the thermoplastic polymer, these granules projecting above the outer surface of the thermoplastic polymer. Water-soluble granules that are partly or fully dissolved while in contact with a moisture-containing food product transfer additive to the food product.

As used herein, the term “film” is used in a generic sense to include plastic web, regardless of whether it is film or sheet. Preferably, films of and used in the present invention have a thickness of 0.25 mm or less. As used herein, the term “package” refers to packaging materials configured around a product being packaged. The phrase “packaged product,” as used herein, refers to the combination of a product that is surrounded by a packaging material.

As used herein, the phrase “laminate” refers to an article having at least two layers. Examples include multilayer film, such as coextruded multilayer film, extrusion coated multilayer film, a monolayer film having a coating thereon, and a multilayer film having a coating thereon, two films bonded with heat or an adhesive, etc. A preferred laminate comprises a substrate layer which is an outer layer of the substrate and which comprises a thermoplastic polymer, and an additive delivery layer, the additive delivery layer comprising a water-insoluble thermoplastic polymer impregnated with granules comprising water soluble colorant, water-soluble odorant, and/or water-soluble flavorant. The substrate layer of the laminate is preferably directly adhered to the additive delivery layer. The substrate film can optionally contain one or more additional film layers, such as an oxygen-barrier layer with or without tie layers in association therewith, additional bulk and/or strength layers, etc. The additive delivery layer is preferably a water permeable layer, i.e. permits water extraction of additives from the additive delivery layer for delivery to an adjacent packaged food. The second additive delivery layer is preferably applied as a coating onto the first substrate film layer.

As used herein, the phrase “outer layer” refers to any layer having less than two of its principal surfaces directly adhered to another layer of the film. The phrase is inclusive of monolayer and multilayer films and laminates. All laminates and all multilayer films have two, and only two, outer layers. Each outer layer has only one of its two principal surfaces adhered to only one other layer of the laminate or multilayer film. In monolayer films, there is only one layer, which, of course, is an outer layer in that neither of its two principal surfaces is adhered to another layer of the film.

As used herein, the phrase “drying,” as used with reference to the process of making the additive delivery laminate, refers to the removal of the organic solvent from the additive delivery slurry to form the additive delivery layer of the laminate. The drying converts the coating of additive delivery slurry on the substrate into a solidified additive delivery layer. The drying can result in an additive delivery layer that does not exhibit substantial blocking, i.e., to avoid sticking to a degree that blocking or delamination occurs, with respect to adjacent surfaces of, for example, a film (including both the same or another film), and/or other articles (e.g., metal surfaces, etc.). Preferably, the dried additive delivery layer has a hydrocarbon solvent content of less than about 5 percent, based on the weight of the outer layer; more preferably, from about 0.0001 to 5 percent; still more preferably, from about 0.0001 to 1 percent; yet more preferably, about 0 percent.

As used herein, the term “seal”, refers to any seal of a first region of a film surface to a second region of the same or another film surface, the seal typically formed by bringing the regions together under pressure and heating each of the film regions to at least their respective seal initiation temperatures to form a heat seal. The sealing can be performed by any one or more of a wide variety of manners, such as using a heated bar, hot air, infrared radiation, ultrasonic sealing, etc., and even the use of clips on, for example, a shirred casing, etc.

As used herein, the phrase “cook-in” refers to the process of cooking a product packaged in a material capable of withstanding exposure to long and slow cooking conditions while containing the food product. The cooked product can be distributed to the customer in the original package, or the packaging material can be removed and the food portioned for repackaging. Cook-in includes cooking by submersion in water at 57° C. to 85° C. for 2-12 hours, or by submersion in water or immersion in pressurized steam (i.e. retort) at 85° C. to 121° C. for 2-12 hours, using a film suitable for retort end-use. However, cook-in can include dry heat, i.e. conventional oven temperatures of 300° F. to 450° F., or microwave cooking, steam heat, or immersion in water at from 135° F. to 212° F. for 2-12 hours. Cooking often involves stepped heat profiles.

Preferably, the food is cooked at a temperature of from about 145° F. to 205° F. for a duration of from about 1 to 12 hours. Alternatively, the food product can be cooked at a temperature of from about 170° F. to 260° F. for a duration of from about 1 to 20 minutes, followed by cooking the food product at a temperature of from about 145° F. to 205° F. for a duration of from about 1 to 12 hours.

Preferably, the food product comprises at least one member selected from the group consisting of beef, pork, chicken, turkey, fish, cheese, tofu, and meat-substitute.

Cook-in packaged foods are essentially pre-packaged, pre-cooked foods that may be directly transferred to the consumer in this form. These types of foods may be consumed with or without warming. Cook-in packaging materials maintain seal integrity, and in the case of multilayer films are delamination resistant. In certain end-uses, such as cook-in casings, the laminate is heat-shrinkable under cook-in conditions so as to form a tightly fitting package. Additional optional characteristics of films for use in cook-in applications include delamination-resistance, low O₂-permeability, heat-shrinkability representing about 20-50% biaxial shrinkage at about 185° F., and optical clarity.

During cook-in, the package should maintain seal integrity, i.e., any heat-sealed seams should resist rupture during the cook-in process. Typically, at least one portion of a cook-in film is heat sealable to another portion to form a backseamed tubular casing, or a seamless tubing is used if a seamless casing is being used. Typically, each of the two ends of the tubular casing are closed using a metal clip. The casing substantially conforms to the product inside the casing. Substantial conformability is enhanced by using a heat-shrinkable film about the package contents so as to form a tightly fitting package. In some embodiments, the film is heat-shrinkable under time-temperature conditions of cook-in, i.e., the film possesses sufficient shrink energy such that exposure of the packaged food product to heat will shrink the packaging film snugly around the packaged product, representatively up to about 55% monoaxial or biaxial shrinkage at 185° F. In this manner, product yield is increased by the food product retaining moisture, and the aesthetic appearance of the packaged product is not diminished by the presence of the surface fluids or “purge”.

As used herein, the phrase the term “elevated temperature” as regards the process of heat processing a packaged food product (either cooked or uncooked) above ambient temperature to initiate the delivery of granular additives, refers to the heat treating of a packaged food above ambient temperature in a material capable of withstanding exposure to heat and time conditions while containing the food product, for example heating the food product to a temperature of from about 45° C. to about 250° C., such as from about 50° C. to about 200° C., or from about 55° C. to about 150° C., or about 57° C. to about 125° C., or about 60° C. to about 115° C., or about 65° C. to about 100° C., or such as about 70° C. to about 85° C. Elevated temperature processing of a packaged food may included stepped heat profiles, for example heating at 57° C. for 30 minutes, followed by heating at 60° C. for 30 minutes, followed by heating to 75° C. until reaching the desired internal food temperature.

The additive delivery laminate is useful for packaging both uncooked food product and cooked food product. That, is, cooking an uncooked food product packaged in the additive delivery laminate can result in the additive being transferred to the food product during cooking. However, the additive delivery laminate can also be used to package a cooked food product, with the additive transferring to the cooked food product during reheating of the food product. Post-pasteruization conditions can be used to transfer the additive to an already cooked food product.

Laminates useful in the present invention may include monolayer or multilayer substrate films. The substrate film may have a total of from 1 to 20 layers; such as from 2 to 12 layers; or such as from 4 to 9 layers. The substrate film can have any total number of layers and any total thickness desired, so long as the substrate provides the desired properties for the particular packaging operation in which the film is used, e.g. O₂-barrier characteristics, free shrink, shrink tension, optics, modulus, seal strength, etc.

As used herein, the phrases “inner layer” and “inside layer” refer to an outer film layer, of a laminate packaging film contacting a product, or an article suitable for use in packaging a product (such as a bag or casing), which is closest to the product, relative to the other layers of the multilayer film.

As used herein, the phrase “outside layer” refers to the outer layer, of a multilayer film or laminate packaging a product, or an article suitable for use in packaging a product (such as a bag or casing), which is furthest from the product relative to the other layers of the multilayer film.

As used herein, the phrase “free shrink” refers to the percent dimensional change in a 10 cm×10 cm specimen of film, when shrunk at 185° F., with the quantitative determination being carried out according to ASTM D 2732, as set forth in the 1990 Annual Book of ASTM Standards, Vol. 08.02, pp. 368-371, which is hereby incorporated, in its entirety, by reference thereto. A heat-shrinkable film has a free shrink of from about 5-70 percent each direction (i.e., from about 5 to 70 percent in the longitudinal (L) and from about 5 to 70 percent the transverse (T) directions) at 90° C., or at least 10 percent at 90° C. in at least one direction; such as from about 10-50 percent at 90° C.; or from about 15-35 percent at 90° C. For conversion to bags and casings, the film article is monoaxially oriented or biaxially oriented, and preferably has a free shrink, at 90° C., of at least 10 percent in each direction (L and T); such as at least 15 percent in each direction. For casing end use, a film has a total free shrink (L+T) of from about 30 to 50 percent at 85° C. For bag end-use, a film has a total free shrink of at least 50% (L+T), such as from 50 to 120%. Alternately, the oriented film article can be heat-set. Heat-setting can be done at a temperature from about 60-200° C., such as 70-150° C. and, such as 80-90° C.

The substrate film used in the present invention can have any total thickness desired, so long as the film provides the desired properties for the particular packaging operation in which the film is used. Preferably, the substrate film used in the present invention has a total thickness , of from about 0.3 to about 15 mils (1 mil=0.001 inch; 25.4 mils=1 mm); such as from about 1 to about 10 mils; or from about 1.5 to about 8 mils. For shrinkable casings, the range from 1.5-8 mils is an example of an acceptable substrate film thickness.

Exemplary substrates which can be coated with the additive delivery coating formulation in accordance with the present invention, which can thereafter be used in accordance with the present invention, include the films disclosed in: (a) U.S. Ser. No. 5,843,502, issued Dec. 1, 1998, in the name of Ram K. Ramesh; (b) U.S. Pat. No. 6,764,729, issued Jul. 20, 2004, in the name of Ram K. Ramesh; (c) U.S. Pat. No. 6,117,464 in the name of Moore, issued Sep. 12, 2000; (d) U.S. Pat. No. 4,287,151, to ESAKOV, et. al., issued Sep. 1, 1981; and (e) U.S. Ser. No. 617,720, in the name of Beckwith et al., filed Apr. 1, 1996. Each of these documents is hereby incorporated in its entirety, by reference thereto.

The following multilayer structures are exemplary of a variety of layer arrangements of additive delivery laminates. The “coating” layer is the additive delivery layer containing the combination of the additive-containing granules, the water-insoluble thermoplastic polymer, and optionally, the polymer toughening agent. All of the layers other than the coating layer represent the substrate portion of the additive delivery laminate. In the following film structures, the individual layers are shown in the order in which they would appear in the laminate:

seal/coating (food-contact)
abuse/seal/coating (food-contact)
abuse/barrier/seal/coating (food-contact)
abuse/tie/barrier/tie/seal/coating (food-contact)
abuse/tie/barrier/tie/bulk/seal/coating (food-contact)
abuse/bulk/tie/barrier/tie/bulk/seal/coating (food-contact)

The foregoing representative film structures are intended to be illustrative only and not limiting in scope.

The heat seal layer can have a thickness of from about 0.1 to about 4 mils, or from about 0.2 to about 1 mil, or from about 0.3 to about 0.8 mil. The outer abuse layer can have a thickness of from about 0.1 to about 5 mils, or from about 0.2 to about 3 mils, or from about 0.3 to about 2 mils, or from about 0.5 to about 1.5 mils. Preferably, the outer abuse layer comprises at least one member selected from the group consisting of polyolefin, polystyrene, polyamide, polyester, polymerized ethylene vinyl alcohol (i.e., hydrolyzed ethylene vinyl acetate copolymer), polyvinylidene chloride, polyester, polyurethane, and polycarbonate

The substrate can optionally comprise an O₂-barrier layer. The O₂-barrier layer is an internal layer of a substrate that is between the seal layer and the abuse layer of the substrate material. The O₂-barrier layer comprises a polymer having relatively high O₂-barrier characteristics. The O₂-barrier layer can have a thickness of from about 0.05 to 2 mils, and can comprise at least one member selected from the group consisting of polymerized ethylene vinyl alcohol (EVOH, which is hydrolyzed ethylene vinyl acetate copolymer), polyvinylidene chloride (including vinylidene chloride/methyl acrylate copolymer and vinylidene chloride/vinyl chloride copolymer), polyamide, polyester, polyacrylonitrile, and polycarbonate.

A multilayer substrate film may optionally further contain a tie layer, also referred to by those of skill in the art as an adhesive layer. The function of a tie layer is to adhere film layers that are otherwise incompatible in that they do not form a strong bond during coextrusion or extrusion coating. Tie layer(s) suitable for use in the film according to the present invention have a relatively high degree of compatibility with (i.e., affinity for) the O₂-barrier layer such as polymerized EVOH, polyamide, etc., as well as a high degree of compatibility for non-barrier layers, such as polymerized ethylene/alpha-olefin copolymers. In general, the composition, number, and thickness of the tie layer(s) is as known to those of skill in the art. Preferably, the tie layer(s) each have a thickness of from about 0.01 to 2 mils. Tie layer(s) each comprise at least one member selected from the group consisting of modified polyolefin, ionomer, ethylene/unsaturated acid copolymer, ethylene/unsaturated ester copolymer, polyamnide, and polyurethane.

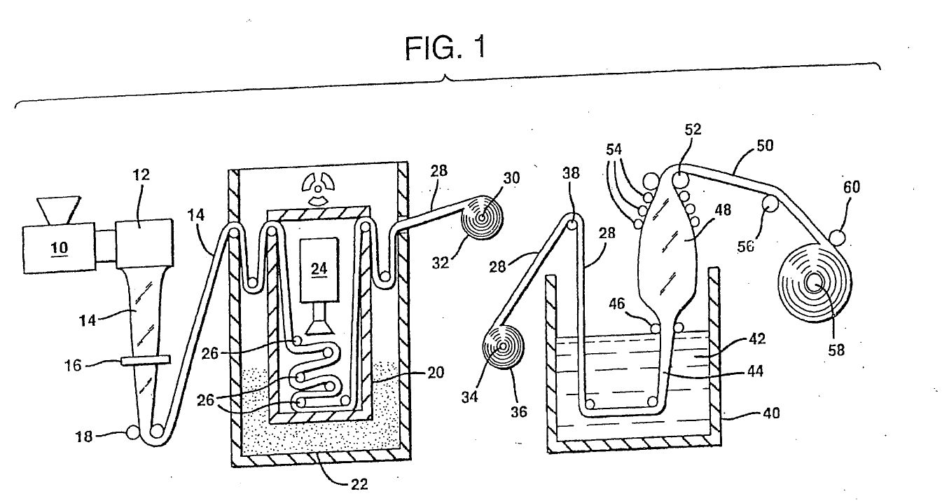

FIG. 1 illustrates a process for making a “substrate film” which can thereafter be coated so that it becomes a film in accordance with the present invention. In the process illustrated in FIG. 1, various polymeric formulations solid polymer beads (not illustrated) are fed to a plurality of extruders (for simplicity, only one extruder is illustrated). Inside extruders 10, the polymer beads are degassed, following which the resulting bubble-free melt is forwarded into die head 12, and extruded through an annular die, resulting in tubing tape 14 which is preferably from about 15 to 30 mils thick, and preferably has a lay-flat width of from about 2 to 10 inches.

After cooling or quenching by water spray from cooling ring 16, tubing tape 14 is collapsed by pinch rolls 18, and is thereafter fed through irradiation vault 20 surrounded by shielding 22, where tubing 14 is irradiated with high energy electrons (i.e., ionizing radiation) from iron core transformer accelerator 24. Tubing tape 14 is guided through irradiation vault 20 on rolls 26. Preferably, tubing tape 14 is irradiated to a level of from about 40-100 kGy, resulting in irradiated tubing tape 28. Irradiated tubing tape 28 is wound upon windup roll 30 upon emergence from irradiation vault 20, forming irradiated tubing tape coil 32.

After irradiation and windup, windup roll 30 and irradiated tubing tape coil 32 are removed and installed as unwind roll 34 and unwind tubing tape coil 36, on a second stage in the process of making the tubing film as ultimately desired. Irradiated tubing 28, being unwound from unwind tubing tape coil 36, is then passed over guide roll 38, after which irradiated tubing 28 is passed through hot water bath tank 40 containing hot water 42. Irradiated tubing 28 is then immersed in hot water 42 (preferably having a temperature of about 85° C. to 99° C.) for a period of about 20 to 60 seconds, i.e., for a time period long enough to bring the film up to the desired temperature for biaxial orientation. Thereafter, hot, irradiated tubular tape 44 is directed through nip rolls 46, and bubble 48 is blown, thereby transversely stretching hot, irradiated tubular tape 44 so that oriented film tube 50 is formed. Furthermore, while being blown, i.e., transversely stretched, nip rolls 52 have a surface speed higher than the surface speed of nip rolls 46, thereby resulting in longitudinal orientation. As a result of the transverse stretching and longitudinal drawing, oriented film tube 50 is produced, this blown tubing preferably having been both stretched in a ratio of from about 1:1.5 to 1:6, and drawn in a ratio of from about 1:1.5 to 1:6. More preferably, the stretching and drawing are each performed at a ratio of from about 1:2 to 1:4. The result is a biaxial orientation of from about 1:2.25 to 1:36, more preferably, 1:4 to 1:16. While bubble 48 is maintained between pinch rolls 46 and 52, trapped bubble 50 is collapsed by converging pairs of parallel rollers 54, and thereafter conveyed through pinch rolls 52 and across guide roll 56, and then rolled onto wind-up roll 58. Idler roll 60 assures a good wind-up. Before windup, the film can optionally be annealed by being heated to an elevated temperature, such as 170° F., while being restrained from shrinking. Annealing can occur even if the film is heated for only a short period of time, such as 15 seconds.

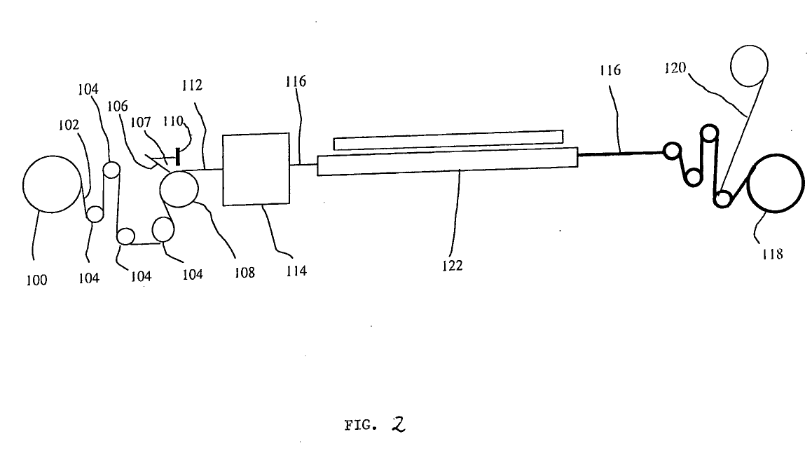

FIG. 2 illustrates a schematic of a knife-over roll process for continuously coating a substrate with an additive delivery slurry, to make an additive delivery laminate. In the schematic process illustrated in FIG. 2, substrate roll 100 supplies substrate film 102 past rollers 104 to knife-over-roll coating apparatus consisting of formulation hopper 106 containing coating formulation 107, roll 108, and knife 110. The resulting coated substrate 112 passes through dryer 114 wherein the solvent is evaporated. The resulting dried additive delivery laminate 116 can then be rolled up onto windup roll 118. However, as even the dried coating can cause the laminate 116 to block to itself, sacrificial interleafing film 120 can optionally be placed on top of the coated additive delivery laminate 116, to prevent blocking. In another optional step, the dried additive delivery laminate can be backseamed in backseaming apparatus 122 before it is wound up onto windup roll 118. In a knife over roller coating process, the additive delivery slurry can have a viscosity within the range of from about 1000 centipoise to about 8000 centipoise, or from about 3500 to about 7500 centipoise, or from about 5000 to about 6000 centipoise.

In the gravure coating process of FIG. 3, engraved roller 124 runs in coating bath 126 which fills the engraved recesses in engraved roller 124 with excess additive delivery slurry 128. The excess slurry 128 on engraved roller 124 is wiped off engraved roller 124 by doctor blade 130, with engraved roller 124 thereafter depositing additive delivery slurry layer 129 onto substrate film 132 as substrate film 132 passes between engraved roller 124 and pressure roller 134.

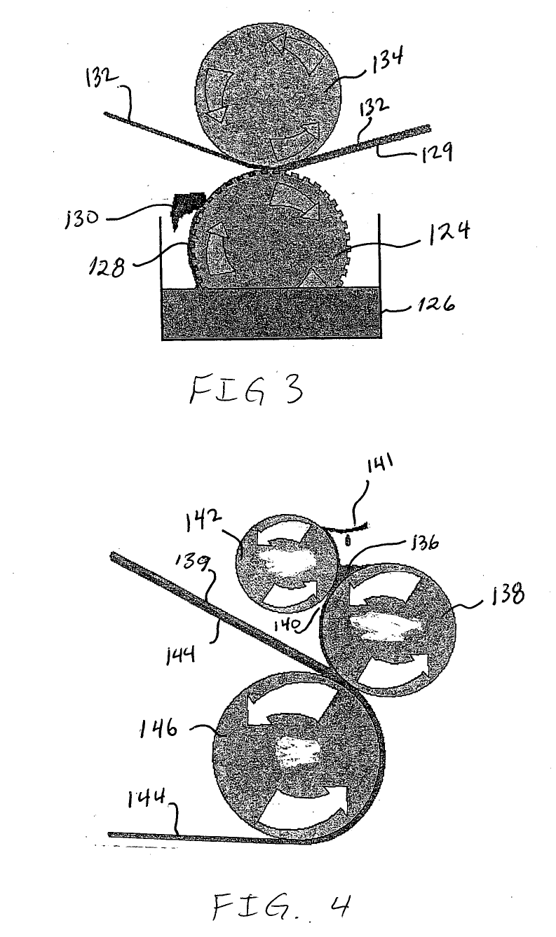

In the 3-roll reverse roll coating process of FIG. 4, additive delivery slurry 136 is measured onto application roller 138 by gap 140 between upper metering roller 142 and application roller 138. The coating is “wiped off” application roller 138 by substrate film 144 as substrate 144 passes around support roller 146, leaving a desired layer 139 of slurry on substrate 144. Additive delivery slurry 136 is confined on metering roller 142 by doctor blade 141.

In the Meyer rod coating process of FIG. 5, an excess coating 148 of the additive delivery slurry is deposited onto substrate film 147 as substrate film 147 passes over bath roller 150, which is immersed in bath 152 containing the additive delivery slurry. Wire-wound Meyer rod 154 allows a desired quantity of the coating to remain on substrate film 147. The quantity of coating remaining is determined by the diameter of the wire used on Meyer rod 154, as well as the distance of the surface of the wire from the substrate film. Although the wire can be in contact with substrate film 147, alternatively the wire can be spaced from substrate film 147 by, for example, 1 to 10 mils, or 2 to 6 mils.

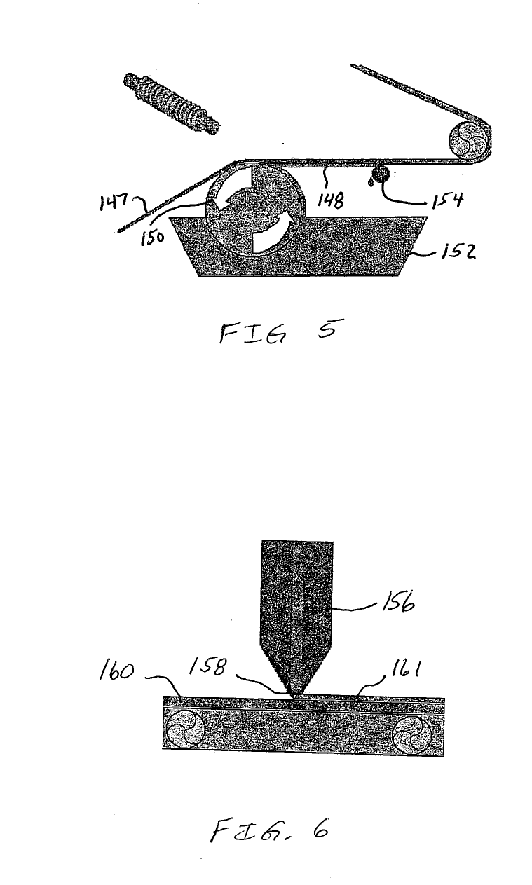

In the extrusion coating process of FIG. 6, additive delivery slurry 156 is extruded through slot 158, forming coating 161 on substrate 160.

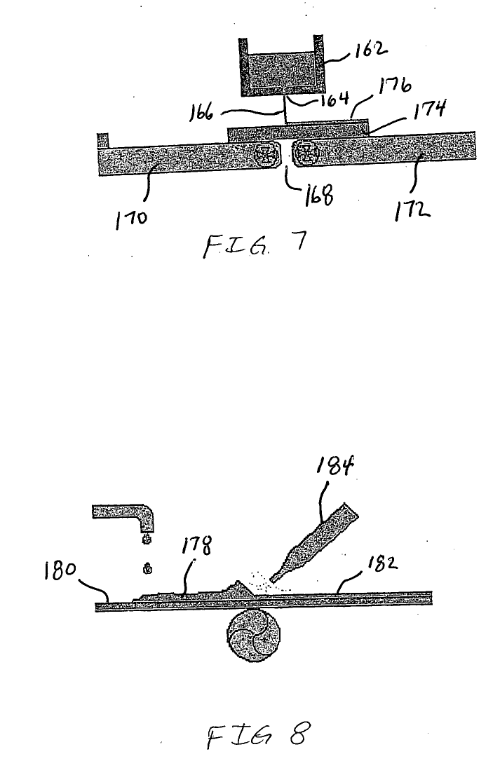

In the curtain coating process illustrated in FIG. 7, bath 162 containing additive delivery slurry has slot 164 in its base, allowing continuous curtain 166 of additive delivery slurry to fall towards gap 168 between conveyors 170 and 172. Substrate 174 is passed along the conveyors 170 and 172 at a controlled speed, receiving coating 176 thereon.

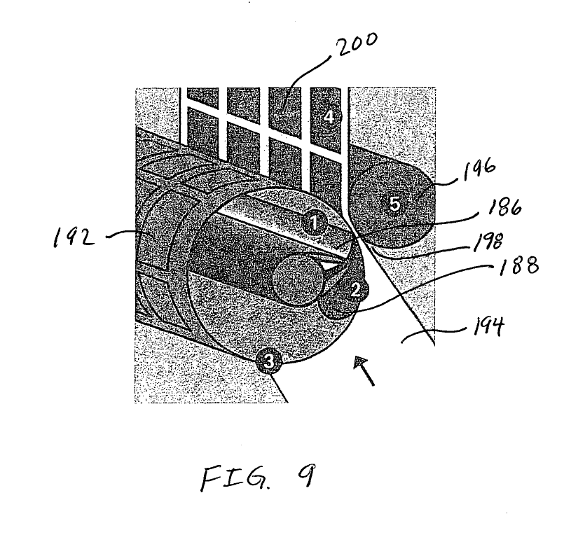

In the air knife coating process of FIG. 8, excess coating 178 is applied to substrate 180, with the excess coating 178 being reduced to a desired coating 182 by the gas flow emanating from blower 184.

In the rotary screen printing process of FIG. 9, a squeegee 186 presses additive delivery slurry 188 through holes in rotary screen 192. Substrate 194 is passed through a nip between rotary screen 192 and counter pressure roller 196, resulting in printed substrate 200. In a rotary screen printing process, the additive delivery slurry can have a viscosity within the range of from about 1000 centipoise to about 8000 centipoise, or from about 2000 to about 6000 centipoise, or from about 3000 to about 5000 centipoise.

### Preparation of Substrate No. 1

A 18¾″ wide (lay-flat dimension) tube, called a “tape”, having a total thickness of about 27 mils, was produced by the coextrusion process described above and illustrated in FIG. 1, wherein the film cross-section (from inside to outside of the tube) was as follows:

TABLE 1

| | | Layer |
|---|---|---|
| Layer Function(s) | | Thickness |
| and Arrangement | Layer Composition | (mils) |
| Seal | LLDPE#1 | 6.6 |
| strength and | blend of 80% EVA#1 and 15% | 2.7 |
| balance | HDPE#1 and 5% Blue MasterBatch | |
| Tie | anhydride-grafted LLDPE#2 | 1.7 |
| strength and | blend of 50% Nylon#1 and 50% | 0.8 |
| moisture barrier | Nylon#2 | |
| O₂-barrier | 100% EVOH | 1.0 |
| Tie | anhydride-grafted LLDPE#2 | 2.8 |
| strength and | blend of 80% EVA#1 and 15% | 6.4 |
| balance | HDPE#1 and 5% Blue MasterBatch | |
| Outside | blend of 90% LLDPE#1 and 10% | 5.0 |
| | Silica Antiblock | |

wherein:
LLDPE#1 was DOWLEX 2244A, linear low density polyethylene, obtained from Dow Plastics, of Freeport.
EVA#1 was PE 1651CS28 (TM) ethylene vinyl acetate copolymer, obtained from Hunstman;
HDPE#1 was FORTIFLEX T60-500-119 high density polyethylene, obtained from BP;
Blue MasterBatch was 16517-18 Blue, blue pigment in LLDPE carrier, obtained from Colortech.
Anhydride-grafted LLDPE#2 was PX3227 linear low density polyethylene having an anhydride functionality grafted thereon, obtained from Equistar;
EVOH was EVAL LC-E105A polymerized ethylene vinyl alcohol, obtained from Eval Company of America, of Lisle, Illinois;
NYLON#1 was ULTRAMID B4 polyamide 6, obtained from BASF corporation of Parsippany, New Jersey;
NYLON#2 was GRILON CF6S polyamide 6/12, obtained from EMS-American Grilon Inc., of Sumter, S.C.; and
Silica Antiblock was 10853 silica in LLDPE from Ampacet.

All the resins were coextruded at between 380° F. and 500° F., and the die was heated to approximately 420° F. The extruded annular tape was cooled with water and placed in a lay-flat configuration, and had a width of 18¾ inches. The tape was then passed through a scanned beam of an electronic cross-linking unit, where it received a total passage of about 64 kilo grays (kGy). After irradiation, the lay-flat tape was passed through steam (approximately 238° F. to 242° F.) for about 60 seconds. The resulting heated tape was inflated into a bubble and oriented 2.6× in the longitudinal direction (i.e., machine direction) and 3.8× in the transverse direction (while the tape was at a temperature above the Vicat softening point of one or more of the polymers therein, but while the polymers remained in the solid state) into a film tubing which was then placed in lay-flat configuration. The lay-flat film tubing had a lay-flat width of 63½ inches and a total thickness of about 2.7 mils. The film was annealed. The bubble was stable and the optics and appearance of the film were good. The film tubing was determined to have about 10% free shrinkage in the longitudinal direction and about 12% free shrinkage in the transverse direction, when immersed in hot water for about 10 seconds, the hot water being at a temperature of 185° F., i.e., using ASTM method D2732-83. The resulting tubing was slit into film.

### Preparation of Substrate No. 2

A 2.4 mil film was made by slitting a tubing made by the process of FIG. 1. The tubing had the following structure:

TABLE 2

| Layer Function(s) | | |
|---|---|---|
| and Arrangement | Layer Composition | Layer Thickness (mils) |
| inside and seal | EPC#1 | 0.53 |
| bulk | VLDPE#1 | 0.51 |
| tie | anhydride-grafted LLDPE#2 | 0.15 |
| O₂-barrier | EVOH | 0.17 |
| tie | anhydride-grafted LLDPE#2 | 0.15 |
| abuse and bulk | blend of 90% EVA#1 and | 0.97 |
| | 10% HDPE#1 | |

EPC#1 was ProFax SA861 ethylene propylene copolymer, obtained from Bassel.
VLDPE#1 was Exact 3128 single site very low density polyethylene from Exxon;
Otherwise, each of the resins was as identified in Substrate No. 1, above.

### Preparation of Substrate No. 3

A 18¾″ wide (lay-flat dimension) tube, called a “tape”, was produced by the coextrusion process described above and illustrated in FIG. 1, wherein the film cross-section (from inside to outside of the tube) was as follows:

TABLE 3

| Layer Function(s) | | Layer Thickness |
|---|---|---|
| and Arrangement | Layer Composition | (mils) |
| seal | LLDPE#1 | 6.6 |
| strength | blend of 80% EVA#1 and 20% | 2.7 |
| | HDPE#1 | |
| tie | anhydride-grafted LLDPE#2 | 1.7 |
| strength and | blend of 50% Nylon#1 and 50% | 0.8 |
| moisture barrier | Nylon#2 | |
| O₂-barrier | 100% EVOH | 1.0 |
| tie | anhydride-grafted LLDPE#2 | 2.8 |
| strength and | blend of 80% EVA#1 and 20% | 6.4 |
| balance | HDPE#1 | |
| outside | blend of 90% LLDPE#1 and 10% | 5.0 |
| | Silica Antiblock | |

In each of the various layers of Substrate No. 3, each of the components are identified above in the description of Substrate No. 1.

All the resins were coextruded at between 380° F. and 500° F., and the die was heated to approximately 420° F. The extruded tape was cooled with water and flattened, the flattened width being 18¾ inches wide in a lay flat configuration. The tape was then passed through a scanned beam of an electronic cross-linking unit, where it received a total passage of about 64 kilo grays (kGy). After irradiation, the flattened tape was passed through steam (approximately 238° F. to 242° F.) for about 60 seconds. The resulting heated tape was inflated into a bubble and oriented (while the tape was at a temperature above the vicat softening point of one or more of the polymers therein, but while the polymers remained in the solid state) into a film tubing having a total thickness of about 2.7 mils. The bubble was stable and the optics and appearance of the film were good. The resulting tubing was slit into film.

### EXAMPLES 1-5

### Preparation of Five Additive Transfer Laminates

A portion of Exxon Vistanex™ MM grade L-120 polyisobutylene (PIB) was removed from a bale and cut into small pellet-sized pieces. The MM grades of PEB rubber could be easily cut with a rubber bale cutter or even a band saw. It could also be shredded by powerful machinery suitable for rubber, such as a Mitts & Merrill Wood Hog or a Cumberland Plastics Granulator. A 10 weight percent solution of the PIB rubber and 0.1 wt. % Foral® AX hydrogenated rosin was prepared with 50 grams of the cut up rubber placed in a sealed glass jar with 450 grams of Isopar™ C (a petroleum fraction containing various hydrocarbons, but primarily composed of isooctane). The mixture was heated (to approximately 75° C.) and agitated until the butyl rubber and hydrogenated rosin was fully dissolved in the Isopar™ C organic solvent. The amount of rubber in solution could be varied from less than 10 wt. % to more than 25 wt. % in preparing an additive delivery slurry capable of providing acceptable results. To the 10 wt. % PEB rubber/1 wt. % hydrogenated rosin solution was added various quantities of granular color, flavor, and/or odor additives, with slow stirring to create a slurry of the granular additives in the solution of polyisobutylene and hydrogenated rosin. About a 2.5:1 mixture of powdered smoke to rubber can be use to provide the correct viscosity and level of flavorant. A variety of formulations were made to produce different flavor and color effects. This entire slurry was then stirred to provide a homogeneous dispersion. Table 4, below, identifies the various materials used to make up five different additive delivery formulations, each containing polyisobutylene and hydrogenated rosin dissolved in Isopar™ C solvent.

TABLE 4

| | Example Number | | | | |
|---|---|---|---|---|---|
| | 1 | 2 | 3 | 4 | 5 |
| Material | Parts By Weight | | | | |
| 10 wt. % Vistanex ™ MM grade L- | 10 | 10 | 10 | 10 | 10 |
| 120 in Isopar ™ C | | | | | |
| Foral ® AX (Pinova Div. of | 0.1 | 0.1 | 0.1 | 0.1 | 0.1 |
| Hercules Inc.) | | | | | |
| Calcium oxide | 0 | 0 | 0 | 0 | 0.05 |
| D-040 powdered smoke (Red | 2.5 | 0 | 2.08 | 2.5 | 2.5 |
| Arrow) | | | | | |
| Caramel #602 (D. D. Williamson) | 0 | 2.5 | 0 | 0 | 0 |
| Caramel #603 (D. D. Williamson) | 0 | 0 | 0.42 | 0 | 0 |
| Caramel #608 (D. D. Williamson) | 0 | 0 | 0 | 0.53 | 0 |

The compositions in Table 4, above, were drawn down using an adjustable coating rod (described below) set at 4 mils onto the seal layer of a film very similar to Substrate No. 1, described above. The resulting wet coatings were allowed to air dry. All the compositions in Table 4 dried to a coating that had good adhesion and abuse characteristics as measured by 600-tape adhesion, fingernail scrape resistance and “crinkle” resistance.

The tape adhesion test was conducted using #600 tape produced by 3M. The sample tested was graded from 1 to 5, with 5 being no removal of the additive delivery coating. The adhesive side of the tape was manually pressed against the additive delivery coating, with the tape thereafter being pulled off of the additive delivery coating. In order to pass this test, the additive delivery layer had to exhibit 100 percent adhesion, i.e., there should be no visible removal of additive delivery layer from the substrate and onto the #600 tape.

The fingernail scrape resistance test was conducted by scraping across the additive delivery layer with the fingernail. If the coating is readily removed by the scraping action of the fingernail, the laminate fails the fingernail scrape resistance test.

Crinkle was tested using a sample which had been allowed to cure (i.e., dry) for at least 24 hours. Crinkle was conducted by crinkling the sample film between hands 10 times (or until heat is generated). The sample is then laid flat and inspected for disruption of the coating's surface, with any more than slight removal of the coating being considered as failing the test.

The additive delivery laminates of Examples 1-5 was used to package meat which was then cooked while packaged. The additive delivery laminates of Examples 1-5 transferred the color and/or smoke flavor to meat at cook-in conditions with little or no amount of the binder transferring to the cooked meat product. It was also discovered that addition of a base (e.g., calcium oxide) to the coating formulation (e.g., Example 5) reduced binder transfer to the meat, especially on some types of meat product (e.g. turkey), compared to additive delivery layers without the base (e.g., Example 1).

### EXAMPLES 6-20

A variety of coating formulations were prepared and thereafter applied to Substrate Film No. 1, described above, to make an additive delivery laminate. The additive delivery laminate was converted to a packaging article by being heat sealed to itself to form a casing, which was then used to package a food product. The food product was then cooked while packaged in the additive delivery laminate. During cooking, one or more additives from the additive delivery layer transferred to the food product, imparting desired color, flavor, and/or fragrance to the food product.

More particularly, the coating formulations were prepared by combining organic solvent, water-insoluble thermoplastic polymer (i.e. polyisobutylene, which is a rubber), a polymer toughening agent (i.e., hydrogenated pine rosin, which is a tackifier) and one or more granular additive agents. In general, about a 1:4 mixture (weight basis) of granular flavor, color, and/or odorant agent(s) to polymer solution was made, resulting in a slurry having the desired viscosity and granular additive level. More particularly, the coating formulation was prepared by removing rubber material from a bale using a utility knife, rubber bale cutter or a band saw, with the rubber thereafter being chopped up using shredding machinery suitable for industrial processing of rubber, such as a Mitts & Merrill Wood Hog, a Cumberland Plastics Granulator, or a Banbury mixer. The Banbury mixer was useful when compounding release additives or other polymers to produce the rubber component of the coating slurry. The chopped rubber component and the hydrogenated pine rosin polymer toughening agent were both then dissolved in a Isopar™ C solvent, using heat and stirring, to create a rubber solution. The flavor, aroma, and/or color granules were then added to the solution of rubber and polymer toughening agent, to produce the slurry. The additive granules were added at a level of from about 20 to 70 percent, based on total weight of the rubber solution. However, the granules could have been added to the rubber solution at a still higher loading.

The resulting slurry was then applied to the seal layer of Substrate No. 1, above, using an adjustable coating applicator obtained from Gardner Lab, Inc., of Bethesda, Md. The stainless steel adjustable coating applicator was made from a rod having a machined groove that tapered from 0 to 10 mil in depth by 8 inches in width. The coating gap was set by aligning marks on steel plates attached by curl nuts on each end of the adjustable coating rod, with the desired gap being marked on the edges of the rod. The coating applicator had a width 8 inches, and was adjustable to apply a coating of from 0 to 10 mils. The applicator was adjusted to apply a coating having a thickness of 4 mils onto Substrate No. 1. As Substrate No. 1 had been slit to a width of approximately 12 inches and the coating applicator was used to apply an 8-inch wide coating to the central portion of the film, Substrate No. 1 was left with uncoated edge portions each of which was about 2 inches in width.

After the coating formulation was applied to the film, it was allowed to air dry, resulting in the additive delivery laminate. Once dried, all of the formulations in Table 5 exhibited good adhesion to Substrate No. 1 and good abuse characteristics. Although air drying of the solvent was utilized, solvent evaporation could have been accelerated by placing the coated substrate in a drying oven. After drying, the granules were present in the dried additive layer at a level of from about 50 to about 85 weight percent, such as from 60 to 80 weight percent, or 70 to 75 weight percent, based on total weight of the additive delivery layer.

The additive delivery laminate was then backseamed with the coating facing inside the resulting tubing. The casing was closed at one end using a metal clip, and the food product (in Examples 6-20, a ham emulsion) was then loaded into the clipped casing after which the other end of the casing tubing was closed to form a packaged product.

While packaged in the casing, the food product was then cooked for 30 minutes at 55° C., followed by 30 minutes at 66° C., followed by 60 minutes at 72° C. After cooking, the product was cooled, and the casing removed from the cooked meat. The color and flavor/aroma in the additive transfer layer transferred to the meat during cooking. In none of Examples 6-20 was it found that the binder (e.g., Vistanex™ MM polybutylene) transferred to or adhered to the cooked meat product. Furthermore, none of the samples exhibited meat pick-off and/or legs due to binder adhesion to the cooked meat product. Depending upon the amount and grade of the colorant used, the resulting color on the meat ranged from light to very dark (see Examples 4-6 and 7-9), or from light to dark (see Examples 15-17 and 18-20). The flavor/aroma varied from weak to strong depending upon the amount of flavorant used (see Examples 7, 8, and 9). As can be seen from the results provided in Table 5, the polyisobutylene did not transfer to the meat product, as there was no “pick-off” and “legs” when removing the cooked meat product from the casing film.

TABLE 5

| | Example No. | | | | | | | | | | | | | | |
|---|---|---|---|---|---|---|---|---|---|---|---|---|---|---|---|
| | 6 | 7 | 8 | 9 | 10 | 11 | 12 | 13 | 14 | 15 | 16 | 17 | 18 | 19 | 20 |
| Parts by weight | | | | | | | | | | | | | | | |
| 10 wt. % Vistanex ™ | 14.3 | 13.5 | 12.5 | 15.2 | 14.4 | 12.8 | 15.2 | 14.4 | 12.8 | 15.2 | 14.4 | 12.8 | 15.2 | 14.4 | 12.8 |
| MM grade L120 | | | | | | | | | | | | | | | |
| and | | | | | | | | | | | | | | | |
| 1 wt. % Foral ® DX | | | | | | | | | | | | | | | |
| in Isopar ™ C | | | | | | | | | | | | | | | |
| D-040 powdered | 0.75 | 1.5 | 3.13 | | | | | | | | | | | | |
| smoke (Red Arrow) | | | | | | | | | | | | | | | |
| Caramel #602 | | | | | | | 0.8 | 1.6 | 3.2 | | | | | | |
| (D. D. Williamson) | | | | | | | | | | | | | | | |
| Caramel #603 | | | | 0.8 | 1.6 | 3.2 | | | | | | | | | |
| (D. D. Williamson) | | | | | | | | | | | | | | | |
| Caramel #608 | | | | | | | | | | 0.8 | 1.6 | 3.2 | | | |
| (D. D. Williamson) | | | | | | | | | | | | | | | |
| Caramel #624 | | | | | | | | | | | | | 0.8 | 1.6 | 3.2 |
| (D. D. Williamson) | | | | | | | | | | | | | | | |
| meat type | H | H | H | H | H | H | H | H | H | H | H | H | H | H | H |
| (H = ham emulsion) | | | | | | | | | | | | | | | |
| Cook-in Results | | | | | | | | | | | | | | | |
| Color | weak | some | some | Light | Dark | very | light | dark | very | light | light | dark | light | light | Dark |
| | | | | | | dark | | | dark | | | | | | |
| Flavor | weak | fair | strong | Not | Not | not | not | not | not | not | not | not | not | not | not |
| | | | | tested | tested | tested | tested | tested | tested | tested | tested | tested | tested | tested | tested |
| Pick-off/legs | no | no | no | No | No | no | no | no | no | no | no | no | no | no | No |

### EXAMPLES 21-40

Table 6, below, provides cook-in results for Examples 21-40, in which various coating formulations were prepared and applied to Substrate No. 1 in a manner corresponding to the manner set forth in Examples 6-20. However, the formulations of Examples 21-40 differed by varying the composition of the polymer toughening agent as well as by inclusion of calcium oxide (i.e., a co-toughening agent and/or release agent) in some of the formulations. The resulting additive transfer laminates were converted to casings and used to package turkey emulsion, with the packaged products being subjected to cook-in as in Examples 6-20.

In general, it was observed that the polymeric toughening agents improved the cohesive strength of the polyisobutylene binder, and reduced the pick-off/legs from the polyisobutylene upon/during removal of the casing from the cooked turkey product after cook-in. Materials such as Staybelite A and rosin esters including Foral® AX, DX, NC and Endere® S served as polymer toughening agents. All of the compositions dried to a coating having good adhesion and abuse characteristics. The color and aroma was transferred to the meat at cook-in conditions. In general, it was observed that there were fewer or no pick-off/legs with the tackifiers, especially when used in conjunction with calcium oxide when the meat was turkey. It was also observed that the grade of the colorant could have an effect on the performance of the coating.

TABLE 6

| | Example No. | | | | | | | | | |
|---|---|---|---|---|---|---|---|---|---|---|
| | 21 | 22 | 23 | 24 | 25 | 26 | 27 | 28 | 29 | 30 |
| parts by weight | | | | | | | | | | |
| 10 wt. % Vistanex | 10 | 10 | 10 | 10 | 10 | 10 | 10 | 10 | 10 | 10 |
| MM grade L120 | | | | | | | | | | |
| in Isopar ™ C | | | | | | | | | | |
| Foral ® AX | 0.1 | | | | | 0.1 | | 0.1 | | |
| oral ® DX | | 0.1 | | | | | 0.1 | | 0.1 | |
| Endere S | | | 0.2 | | | | | | | |
| Foral NC | | | | 0.1 | | | | | | |
| Staybelite A | | | | | 0.1 | | | | | |
| Calcium Oxide | | | | | | 0.05 | 0.05 | | | |
| D-040 powdered | | | | | | | | | | |
| smoke (Red Arrow) | 2.5 | 2.5 | 2.5 | 2.5 | 2.5 | 2.5 | 2.5 | 2.5 | 2.5 | 2.5 |
| Caramel #603 (D. D. Williamson) | 0.53 | 0.53 | 0.53 | 0.53 | 0.53 | 0.53 | 0.53 | 0.53 | | |
| Caramel #624 (D. D. Williamson) | | | | | | | | | 0.53 | 0.53 |
| meat type | T | T | T | T | T | T | T | T | T | T |
| (T = turkey emulsion) | | | | | | | | | | |
| Cook-in Results | | | | | | | | | | |
| Color | good | good | good | good | good | Good | Good | good | good | good |
| Flavor | good | good | good | good | good | Good | Good | good | good | good |
| Pick-off/legs | some | few | few | Few | few | No | No | few | few | few |
| | Example No. | | | | | | | | | |
| | 31 | 32 | 33 | 34 | 35 | 36 | 37 | 38 | 39 | 40 |
| parts by weight | | | | | | | | | | |
| 10 wt. % Vistanex | 10 | 10 | 10 | 10 | 10 | 10 | 10 | 10 | 10 | 10 |
| MM grade L120 | | | | | | | | | | |
| in Isopar ™ C | | | | | | | | | | |
| Foral ® AX | | | | 0.1 | | | 0.1 | 0.1 | 0.1 | 0.1 |
| Foral ® DX | | | | | 0.1 | | | | | |
| Endere S | 0.2 | | | | | | | | | |
| Foral NC | | 0.1 | | | | | | | | |
| Staybelite A | | | 0.1 | | | | | | | |
| Calcium Oxide | | | | 0.05 | 0.05 | | 0.05 | 0.05 | 0.05 | 0.05 |
| D-040 powdered | | | | | | | | | | |
| smoke (Red Arrow) | 2.5 | 2.5 | 2.5 | 2.5 | 2.5 | 2.5 | 2.5 | 2.5 | 2.5 | 2.5 |
| Caramel #603 (D. D. Williamson) | | | | | | | 0.53 | 0.4 | 0.26 | 0.13 |
| Caramel #624 (D. D. Williamson) | 0.53 | 0.53 | 0.53 | 0.53 | 0.53 | 0.53 | | | | |
| meat type | T | T | T | T | T | T | T | T | T | T |
| (T = turkey emulsion) | | | | | | | | | | |
| Cook-in Results | | | | | | | | | | |
| Color | good | good | good | good | good | good | good | good | fair | poor |
| Flavor | good | good | good | good | good | good | good | good | good | good |
| Pick-off/legs | some | some | some | no | no | some | no | no | no | no |

### EXAMPLES 41-44

Table 7, below, provides cook-in results for Examples 41-44, in which various coating formulations were prepared and applied to Substrate No. 1 in the same manner as set forth in Examples 6-20. The resulting coated films were used to package a variety of different types of meat emulsions, with the packaged products being subjected to cook-in as in Examples 6-20.

The cook-in results revealed that different meat types behave differently when cooked using the same or similar flavor and/or color compositions in accordance with the present invention. Basic compounds such as calcium oxide were found to improve desired cook-in properties with certain meat types (e.g., turkey, as in Example 42), while being detrimental with respect to the same cook-in property for other meat types (e.g., ham, as in Example 41).

All of the compositions dried to a coating which exhibited good adhesion and abuse characteristics. The color and/or smoke flavor transferred to the meat at cook-in conditions with reduced amount of binder transferring (and reduced legs) to the turkey and beef meat products, but with significantly more pick-off/legs with the ham product.

TABLE 7

| | Example No. | | | |
|---|---|---|---|---|
| Parts by weight | 41 | 42 | 43 | 44 |
| 10 wt. % Vistanex ™ MM grade L120 | 10 | 10 | 10 | 10 |
| in Isopar ™ C | | | | |
| Foral ® AX | 0.1 | 0.1 | 0.1 | 0.1 |
| Calcium Oxide | 0.05 | 0.05 | | 0.05 |
| D-040 powdered smoke (Red Arrow) | 2.5 | 2.5 | 2.5 | |
| Caramel #603 (D.D. Williamson) | | | | 2.5 |
| meat type | H | T | T | B |
| Cook-in Results | | | | |
| Color | good | good | good | good |
| Flavor | good | good | good | not tested |
| Pick-off/legs | many | no | some | No |

H = Ham Emulsion;
T = Turkey Emulsion;
B = Beef Emulsion

### EXAMPLES 45-56

Table 8, below, provides cook-in results for Examples 45-56, in which various coating formulations were prepared and applied to Substrate No. 1 in the same manner as set forth in Examples 6-20. However, the formulations of Examples 45-56 differed in that they did not contain flavor/aroma additives. The resulting coated films were converted to casings and then used to package ham emulsion, turkey emulsion, and beef emulsion, with the packaged products thereafter being subjected to cook-in as in Examples 6-20.

The cook-in results revealed that the meat which was cooked in the uncoated film (i.e., Examples 51, 52, and 53) exhibited meat adhesion and legs, indicating that these undesirable characteristics may not be from the polybutylene binder alone (compare the results of Examples 51-53 with the results of Examples 45-50). It is believed that this result occurred because the film of Substrate No. 1 was corona treated, producing polar sites on the surface of the seal layer, causing excessive adhesion of the film to the meat product.

[symbol]

TABLE 8

| | Example No. | | | | | | | | | | | |
|---|---|---|---|---|---|---|---|---|---|---|---|---|
| | 45 | 46 | 47 | 48 | 49 | 50 | 51 | 52 | 53 | 54 | 55 | 56 |
| Parts by weight | | | | | | | | | | | | |
| 10 wt. % Vistanex | 10 | 10 | 10 | 10 | 10 | 10 | None | None | None | 10 | 10 | 10 |
| MM grade L120 in | | | | | | | | | | | | |
| Isopar ™ C | | | | | | | | | | | | |
| Calcium Oxide | 0.05 | 0.05 | 0.05 | | | | | | | | | |
| Citric Acid | | | | | | | | | | 0.05 | 0.05 | 0.05 |
| meat type | H | T | B | H | T | B | H | T | B | H | T | B |
| Cook-in Results | | | | | | | | | | | | |
| Pick-off/legs | few | very | very | few | Very | very | adhesion/legs | adhesion/legs | adhesion/legs | few | no | Some |
| | | few | few | | few | few | | | | | | |

H = Ham Emulsion;
T = Turkey Emulsion;
B = Beef Emulsion

### EXAMPLES 57-66

Table 9, below, provides the coating composition and cook-in results for Examples 57 to 66, in which various coating formulations were prepared and applied to the base film in the same manner as set forth in Examples 6-20. Each of the coating formulations in Examples 57-66 contained the same type and amount of polybutylene and organic solvent (i.e., 10% Vistanex™ MM grade L120 polybutylene in Isopar™ C), the same type and amount of polymer toughening agent (Foral® AX hydrogenated rosin), the same type and amount of powdered smoke (D-040 powdered smoke), and the same type and amount of caramel (Caramel #603). However, the coatings on Examples 57-59 further contained various amounts of talc (Vantalc F2300); the coatings on Examples 60-62 further contained various amounts of mica (Alsibronz 10); the coatings of Examples 63-65 further contained various amounts of silica (Aerosil 200). The coating of Example 66 contained no such inorganic additive. The resulting coated films were converted to casings and used to package ham emulsion, with the packaged products being subjected to cook-in as in Examples 6-20.

Table 9 provides the cook-in results. The color and aroma transferred to the meat product at cook-in conditions. However, as is apparent from a comparison of the results using the inorganic additive (i.e, the results of Examples 57-65) with Example 66 (i.e., the control which did not include any talc, mica, or silica, or other inorganic additive, there was no improvement in color, aroma, or pick-off/legs. Moreover, one of the inorganic additives (i.e., Aerosil 200) degraded the desired color and pick-off/legs.

TABLE 9

| | Example No. | | | | | | | |
|---|---|---|---|---|---|---|---|---|
| | 57 | 58 | 59 | 60 | 61 | 62 | 63 | 64 |
| parts by weight | | | | | | | | |
| 10 wt. % Vistanex ™ MM grade L120 in Isopar ™ C | 10 | 10 | 10 | 10 | 10 | 10 | 10 | 10 |
| Foral ® AX | 0.1 | 0.1 | 0.1 | 0.1 | 0.1 | 0.1 | 0.1 | 0.1 |
| D-040 powdered smoke (Red Arrow) | 2.08 | 2.08 | 2.08 | 2.08 | 2.08 | 2.08 | 2.08 | 2.08 |
| Caramel #603 (D. D. Williamson) | 0.42 | 0.42 | 0.42 | 0.42 | 0.42 | 0.42 | 0.42 | 0.42 |
| Vantalc F2003 (R. T. Vanderbilt) | 0.05 | 0.1 | 0.15 | | | | | |
| Alsibronz 10 (Engelhard Corp.) | | | | 0.05 | 0.1 | 0.15 | | |
| Aerosil 200 (Degussa) | | | | | | | 0.05 | 0.1 |
| meat type | H | H | H | H | H | H | H | H |
| H = Ham Emulsion | | | | | | | | |
| Cook-in Results | | | | | | | | |
| Color | good | good | good | good | good | good | spotty | spotty |
| Aroma | good | good | good | good | good | good | good | good |
| Pick-off/legs | little | little | little | little | little | little | some | some |

### EXAMPLE 67

### Knife over Soft Roller Process

An additive delivery laminate was prepared by coating substrate, which was a multilayer flexible packaging film (i.e., Substrate No. 1, described above), with an additive delivery slurry comprising granules of colorant, flavorant, and/or odorant in a solution of polyisobutylene and hydrogenated rosin ester dissolved in hexane. The coating was carried out by applying the additive delivery slurry to the seal layer of Substrate No. 1 using a Rotary Koater, available from R.K. Koater Company, Ltd. The Rotary Koater (further referred to as the RK coater) was a versatile laboratory coating apparatus that was adaptable to coat, print, or laminate materials with different processes. Some of the process applications that were available were: Two Roll Nip Feed, Meter Bar, Reverse Roll, Flexographic, Rotary Screen, Gravure Offset, and Knife over Roll. A separate adaptable unit is needed for each application.

The additive delivery slurry was prepared as follows. A portion of Exxon Vistanex™ MM grade L-120 polyisobutylene (PIB) was removed from a bale and cut into small pellet-sized pieces. The MM grades of PIB rubber could be easily cut with a rubber bale cutter or even a band saw. It could also be shredded by powerful machinery suitable for rubber, such as a Mitts & Merrill Wood Hog or a Cumberland Plastics Granulator. A 10 weight percent solution of the PIB rubber was prepared with 50 grams of the cut up rubber placed in a sealed glass jar with 450 grams of hexane. The mixture was heated (to approximately 75° C.) and agitated until the butyl rubber was fully dissolved in the hexane. The amount of rubber in solution could be varied from less than 10 wt. % to more than 25 wt. % in hexane in making color/favor transfer slurry with acceptable results. About 5 grams of the Foral AX hydrogenated wood rosin was also dissolved in the hexane. The hydrogenated wood rosin served as a polymer toughening agent to reduce pick-off of the PIB and legs.

To the 10 wt. % PIB rubber solution was added 93 grams of Red Arrow Products Chardex Hickory D-040 powdered smoke flavor and 32 grams of D.D. Williamson Caramel #603, with slow stirring to create the slurry of granular additives in rubber solution. About a 2:1 mixture of powdered smoke to rubber provided the desired viscosity and level of flavorant. A variety of formulations can be made to produce different flavor and color effects. This entire slurry was then stirred to provide a homogeneous dispersion. Table 10, below, provides a summary of the contents of the additive delivery slurry.

TABLE 10

| Wt % | Ingredient | Tradename | Supplier |
|---|---|---|---|
| 71.46 | Hexane | 3002420 | Ashland |
| 7.94 | PIB | Vistanex ® MM L120 | Exxon |
| 16.5 | Hickory | Chardex Hickory | Red Arrow |
| 3.3 | Caramel | #603 Powdered | DD Williamson |
| | | Caramel | |
| 0.8 | Rosin | Floral ® AX | Hercules |

The coating process was carried out using the RK coater in a knife-over-roll configuration. The RK coater had a backing roller having a diameter of about 3 inches and a length of about 14 inches. This roller was covered with foam Cellu-Cushion 120 polyethylene foam from Sealed Air, having a density of 0.03 g/cc, a thickness of ½ inch, and a Shore A Scale hardness of about 10. The foam was adhered to the backing roller with double stick tape. The gap between the knife and the surface of the soft roller was set at 8 mils.

The soft knife over roll coating apparatus was used to apply a relatively heavy coating to the substrate film. The viscosity of the coating formulation was about 5,600 centipoise, the viscosity could have been within the range of from about 1000 to about 8,000 centipoise, or from about 3500 to about 7,500 centipoise, or from about 5,000 to about 6,000 centipoise. The wet film coating thickness ranged from about 25 to about 125 microns. The target wet laydown thickness for the coating applied to Substrate No. 1 was 4 mils (i.e., about 100 microns). The height of the coating knife was adjustable with micrometers on each side of the knife. The angle of the blade was also adjustable, and was set to 90°. The coating width was maintained by an adjustable check control on each side of the coating. This adjustable check control was referred to as end dams. An ample amount of coating was retained by the end dams to ensure continuous feeding of the coating and deter drying on the knife.

The powdered caramel and hickory were not classified to any specific size. The purpose of the foam was to adequately soften the roller to allow all the components of the coating to pass under the knife.

Previous attempts to use the Knife-over-Roll process with these unclassified granular materials and a hard roller were not successful due to the range in particle size and the tendency of the powders to agglomerate into larger particles. The hard roller prevented the larger particles from passing underneath the knife, resulting in streaking in the final coated product. The granules agglomerated so that as one particle hung under the knife others would group around it causing the streak to widen. This usually happened within minutes of applying the coating. The softer durometer of the foam-coated roller allowed larger granules, and even groups of granules that were too large to pass underneath the knife, to press down into the foam and move underneath the knife. This ultimately provided for a greater color/flavor intensity and for a more natural (i.e,, heterogeneous) appearance of the coating as it related to its end use application. Several oil-fried applications were speckled in appearance and the presence of the larger particles promoted that appearance.

Moreover, some of the cell structure of the foam was imprinted in the coating. Having observed this, additional work was done with other materials covering the backing roll that would impart a pattern, as set forth in Examples 68-70, below.

### EXAMPLE 68

The same process, substrate and coating were used to produce additive delivery laminate, except that a harder rubber plate (i.e., Shore A Scale hardness of about 20) engraved with a ½ inch by ½ inch rectangular grid pattern was placed on the backing roller. The lines making up the grid were elevated 10 mils higher than the area within each of the rectangles, of the grid. The lines had a width of about 1/32 inch. The coating knife was lowered to point that it just contacted the film. The 10 mil relief of the grid pattern allowed the coating knife to cleanly sweep the coating formulation from the raised area of the engraved hard rubber plate, and the shallow areas of the grid retained the coating formulation. As Substrate No. 1 contacted the hard rubber plate, coating formulation within the depressed areas transferred to Substrate No. 2. The coating was dried by passing the coated substrate through a drying tunnel having a temperature of from about 140° F. to 150° F. for a period of about 60 seconds. Hams packaged and cooked in the film exhibited a color effect mimicking the netting effect of hams hung in netting. That is, the area under the netting was lighter than the open areas.

### EXAMPLE 69

The same substrate and coating formulation used in Example 67 and 68 were used to produce a patterned additive delivery laminate in a knife-over-roll process. However, a hard rubber plate engraved with the reverse of the pattern of Example 68 was placed on the backing roller. While the pattern applied in Example 68 was one that imparted a netted look to the meat (meaning that the cells were filled with coating transferring the smoke color and flavor from the cells leaving a clear line where the raised grid lines were), the pattern applied in Example 69 resulted in grill marks (i.e., the “cell” portions of the pattern were raised areas of the rubber plate, and the grid lines held the coating and transferred the color/flavor to the meat). The reverse grid pattern had 10 mil relief, with each square having a width of about 1 inch and a length of about 1 inch. In this reverse grid pattern, the internal portion of each rectangle was the raised area, with the lines defining the rectangles being recessed 10 mils. The lines had a width of about 1/16 inch. The coating knife was lowered to the point that it just contacted the film. As a result, any area that was raised on the rubber plate was swept clean by the coating knife and any of the shallow areas of the grid retained the coating. The resulting additive delivery laminate had an additive delivery layer possessing a pattern resembling grill marks. The width of the coating could be varied by altering the width of the lines defining the grid.

### EXAMPLE 70

The same process, substrate and coating used in Example 67-69 were used to produce yet additional samples. However, a softer photopolymer plate with a grill marks surrounding a central graphic (depicting the image of a pig) was placed on the backing roller. The photopolymer plate was softer that the hard rubber plate. The degree of relief in the photopolymer plate was 10 mil, and the coating knife was lowered to a point that it was just contacting the substrate film to be coated with the additive delivery slurry. As a result, any area that was raised on the photopolymer plate was swept clean by the coating knife, with the shallow depressions in the photopolymer plate holding the additive transfer slurry which transferred to the substrate film upon contact therewith. The resulting pattern coated onto the substrate represented grill marks surrounding the image of the pig. Such a pattern, transferring to a cooked meat product, could serve as a logo or trademark indicating the source of the cooked meat product.

### EXAMPLES 71-79

### Spray Coating the Substrate

Substrate No. 2, described above, was a 2.4 mil cook-in film. This film was converted into cook-in bags. The bags were inverted (i.e., turned inside out) and slipped over a mandrel and dried before being sprayed an additive delivery slurry. Spraying was conduced using a Binks HVLP gravity fed spray gun, configured by Air Power Inc., operated with clean dry air (25 to 40 psig) under ambient conditions (65° F.-78° F.). Table 11, below, provides the content of the additive delivery slurry for Examples 5-10.

TABLE 11
(percent data is weight percent, all other data is parts by weight)

| | Formulation of Example No. | | | | | | | | |
|---|---|---|---|---|---|---|---|---|---|
| | 71 | 72 | 73 | 74 | 75 | 76 | 77 | 78 | 79 |
| 10 wt. % Vistanex ™ MM | 6.3 | 9.38 | 3.14 | | | | | | |
| grade 120, | | | | | | | | | |
| 1 wt. % Foral ® AX, | | | | | | | | | |
| 16.5 wt % D-040 | | | | | | | | | |
| powdered smoke, | | | | | | | | | |
| 3.3 wt. % Caramel #603, | | | | | | | | | |
| in Isopar ™ C | | | | | | | | | |
| 10 wt. % Vistanex ™ MM | | | | | 10 | | | | |
| grade 120, | | | | | | | | | |
| 1 wt. % Foral ® DX, | | | | | | | | | |
| in Isopar ™ C | | | | | | | | | |
| 11 wt. % Vistanex ™ MM | | | | 10 | | 10 | 10 | 10 | 10 |
| grade 120, in hexane | | | | | | | | | |
| Foral ® DX hydrogenated | | | | 0.1 | 0.1 | 0.1 | 0.1 | | |
| wood rosin | | | | | | | | | |
| D-040 Powdered Smoke | | | | 2.5 | 2.5 | | 2.08 | 2.08 | 2.08 |
| (Red Arrow) | | | | | | | | | |
| Caramel #602 (DD Williamson) | | | | | | 2.5 | | | |
| Caramel #608 (DD Williamson) | | | | 0.53 | 0.53 | | | | |
| Isopar ™ C organic solvent | 6.3 | 3.13 | 9.4 | | 13.13 | | | | |
| Hexane | | | | 13.13 | | 12.6 | 12.6 | 12 | 12.5 |
| Foral ® AX hydrogenated | | | | | | | | 0.1 | 0.1 |
| wood rosin | | | | | | | | | |
| Caramel #603 (DD Williamson) | | | | | | | 0.42 | 0.42 | 0.42 |
| Himaize | | | | | | | | 0.6 | |

The various granular additives were air classified in a manner so as to remove nearly all granules having a maximum dimension of greater than 75 microns. The additive delivery slurry formulation of Example 71 exhibited the best properties for spraying. The formulation of Example 73 was too viscous to produce a coating with the desired appearance, and the formulation of Example 72 was too thin to produce a coating with the desired appearance. The formulations of each of Examples 71, 72, and 73 did not dry well, and were tacky to the touch.

The formulations of Examples 74, 75, and 76 used hexane as the solvent. Each of these formulations exhibited better spray characteristics than the formulations of Examples 71, 72, and 73, i.e., uniform spray patterns and uniform coverage of 14-22 grams per square meter. Meat product cooked in the additive delivery laminates of Examples 71, 72, and 73 exhibited good color and good flavor.

The formulation of Example 77 was hexane based, but was diluted 50% with additional hexane for better spray properties (i.e., non-clogging, good pattern and uniform coating weight of 20-22 grams/square meter. The formulation of Example 79, which resulted in good coating coverage and good spray pattern, was the same as the formulation of Example 77, but further contains himaize anti-blocking material. The formulation of Example 79 yielded acceptable smoked color and flavor.

In a spray coating process, the additive delivery slurry can have a viscosity within the range of from about 100 centipoise to about 2000 centipoise, or from about 200 to about 1000 centipoise, or from about 300 to about 800 centipoise.

### EXAMPLES 80-84

### Additive Delivery Laminate Prepared via Rotary Screen Printing

Several additive delivery slurry formulations were prepared and applied to a Substrate No. 1, described above. Additive delivery slurry was applied to Substrate No. 1 using rotary screen printing at Stock Boxmeer (Stock Prints B.V., P.O. Box 67, 5830 AB Boxmeer, The Netherlands, can be contacted via Stock Prints America, Inc., P.O. Box 24658, Charlotte, N.C. 29221).

Table 12 provides the compositions of the additive delivery slurry formulations utilized in Examples 80-84.

The Isopar C-based formulation was slow drying in the oven and operating speed was reduced to 5 meters per minute. The hexane-based formulation dried quickly but resulted in patchy transfer, as well as drying of the Vistanex polyisobutylene in the rotary screens. Three formulations containing the blend of the Isopar C formulation with the hexane formulation provided favorable operating speeds and drying times. Reasonable drying times could be obtained by blending a hexane-based formulation with 1%, 5%, and 10% Isopar C.

Stork screens of various mesh sizes and open areas were evaluated, including a HX 25/300 screen with 30% and 40% open areas and a 91.4 cm repeat, and a HX 30 and RMS 75/46 screens were also used in trials with good results. Rotary screen printing was successfully operated at speeds varying from 2 meters per minute to 40 meters per minute using the above-described screens and formulations. Dry coating weights of from 15 to 24 grams per square meter were obtained. A uniform coating pattern with good definition of the bag profile was also obtained.

TABLE 12
(percent data is weight percent, all other data is parts by weight)

| | Formulation of Example No. | | | | |
|---|---|---|---|---|---|
| | | | 82 | | |
| | | | (a 50/50 | | |
| | | | mix | | 84 |
| | 80 | 81 | of 10% | | (with |
| | (with 10% | (with 5% | Vistanex in | 83 | 10% |
| | Isopar ™ | Isopar ™ | Isopar ™ C | (with | Isopar ™ |
| | C added) | C added) | and hexane) | hexane) | C) |
| 10 wt. % | 10 | 10 | 5 | 10 | 0 |
| Vistanex ™ | | | | | |
| MM grade | | | | | |
| 120, in | | | | | |
| hexane | | | | | |
| D-040 | 2.08 | 2.08 | 2.08 | 2.08 | 2.08 |
| Powdered | | | | | |
| Smoke | | | | | |
| (Red Arrow) | | | | | |
| Isopar ™ C | 1 | 0.5 | 5 | 0 | 11¹ |
| Organic | | | | | |
| solvent | | | | | |
| Foral ® AX | 0.1 | 0.1 | 0.1 | 0.1 | 0.1 |
| hydro- | | | | | |
| genated | | | | | |
| wood | | | | | |
| rosin | | | | | |
| Caramel | 0.42 | 0.42 | 0.42 | 0.42 | 0.42 |
| #603 | | | | | |
| (DD | | | | | |
| Williamson) | | | | | |

¹Includes 1 part by weight Vistanex ™ MM Grade 120

Rotary screen printing can be used in a continuous printing operation, with the substrate film being forwarded continuously. Rotary screen printing of the substrate provides the advantage of precise regulation of the coated area of the film in a repeated pattern which need not be continuous along a continuous film substrate being coated. Such a pattern can, for example, provide the shape of the interior of a bag, casing, or other packaging article. More particularly, the printing can be patterned so that uncoated regions are located in regions for subsequent heat sealing, as it can be very difficult to form a hermetic heat seal through a relatively thick additive delivery transfer layer. Rotary screen printing can provide a repeating, discontinous printed pattern to a continuous flat film substrate, so that the substrate can be converted into side seal bags, L-seal bags, U-seal bags, backseamed casings (including fin seal casings, lap seal casings, and butt-sealed backseamed casings), as well as printing logos and other specialized patterns which can then be transferred to a food product.

What is claimed is:

1. A process for preparing a laminate, comprising:
(A) dispersing water-soluble granules comprising at least one member selected from the group consisting of colorant, flavorant, and odorant into a polymer solution comprising a thermoplastic polymer and an organic solvent, to make an additive delivery slurry;
(B) depositing the additive delivery slurry onto a substrate;
(C) evaporating the organic solvent from the additive delivery slurry deposited onto the substrate, to form a laminate having a substrate layer and an additive delivery layer, with the additive delivery layer comprising the water-soluble granules.

2. The process according to claim 1, wherein the organic solvent and thermoplastic polymer are heated so that the thermoplastic polymer dissolves in the organic solvent.

3. A process for preparing an additive delivery laminate, comprising:
(A) providing an additive delivery slurry comprising an organic solvent, a water-insoluble thermoplastic polymer dissolved in the organic solvent, and additive granules dispersed in the organic solvent, the additive granules comprising at least one member selected from the group consisting of colorant, flavorant, and odorant;
(B) applying a coating of the additive delivery slurry onto a substrate;
(C) evaporating the organic solvent from the additive delivery slurry to form an additive delivery layer on the substrate.

4. The process according to claim 3, wherein the additive delivery slurry further comprises a polymer toughening agent.

5. The process according to claim 3, wherein the additive delivery slurry is applied to the substrate using a knife-over-roller coating process, with the substrate being a film passing over the roller and between the knife and the roller.

6. The process according to claim 5, wherein the knife is spaced from the film by a distance of from about 4 mils to about 6 mils.

7. The process according to claim 5, wherein the roller has an outer substrate contact surface having a pattern of depressions, and the knife is in direct contact with the substrate, so that a patterned coating is applied to the substrate.

8. The process according to claim 5, wherein the roller has an outer film contact surface having a Shore A hardness of from about 1 to 30.

9. The process according to claim 4, wherein the roller has an outer film contact surface having a Shore A hardness of from about 2 to about 10.

10. The process according to claim 3, wherein the additive delivery slurry has a viscosity of from about 500 to 10,000 centipoise.

11. The process according to claim 3, wherein the additive delivery slurry is applied to the substrate by spraying the additive delivery slurry onto the substrate.

12. The process according to claim 11, wherein the additive delivery slurry has a viscosity of from about 100 to about 2000 centipoises. [200-1000; 300-800]

13. The process according to claim 11, wherein the spraying is conducted using a high volume low pressure sprayer.

14. The process according to claim 11, wherein the additive delivery slurry comprises at least one member selected from the group consisting of C₅ to C₁₂ alkane and alkene, C₃ to C₆ aliphatic alcohol, C₃ to C₅ aliphatic ketone, and C₃ to C₁₂ organic ester.

15. The process according to claim 11, wherein the additive delivery slurry comprises a blend of from about 5 to about 70 weight percent iso-octane and from about 30 to about 95 weight percent of at least one member selected from the group consisting of hexane, heptane, pentane, and butane.

16. The process according to claim 11, wherein the additive granules have been classified so that they have a maximum dimension of 150 microns.

17. The process according to claim 3, wherein the additive delivery slurry is applied to the substrate at a level so that after evaporation of the solvent, the resulting additive delivery layer has a weight of from about 5 to 50 grams per square meter.

18. The process according to claim 5, wherein the additive delivery slurry is screen printed onto the substrate.

19. The process according to claim 18, wherein the additive delivery slurry is rotary screen printed onto the substrate.

20. The process according to claim 19, wherein the additive granules have been classified so that they have a maximum dimension of 150 microns.

21. The process according to claim 19, wherein the additive delivery slurry has a viscosity of from about 1000 to about 8000 centipoises.

22. The process according to claim 19, wherein the additive delivery slurry comprises at least one member selected from the group consisting of C₅ to C₁₂ alkane and alkene, C₃ to C₆ aliphatic alcohol, C₃ to C₅ aliphatic ketone, and C₃ to C₁₂ organic ester.

23. The process according to claim 21, wherein the organic solvent in the additive delivery slurry comprises a blend of from about 5 to about 30 weight percent iso-octane and from about 70 to about 95 weight percent of at least one member selected from the group consisting of hexane, heptane, pentane, and butane.

24. The process according to claim 19, wherein the screen has holes having a diameter at least three times a maximum dimension of the granules in the additive delivery slurry.

25. The process according to claim 3, wherein the water-insoluble thermoplastic polymer comprises at least one member selected from the group consisting of styrene-butadiene rubber, isobutylene/isoprene copolymer (e.g., butyl rubber), crosslinked butyl rubber, polyisoprene, polyisobutylene, polybutylene, styrene/isobutylene copolymer, ethylene/vinyl acetate copolymer, polybutadiene, ethylene/cyclo-olefin copolymer, polyvinyl acetate, cellulose triacetate, natural rubber, chicle, and balata rubber.

26. The process according to claim 3, wherein the additive delivery slurry is applied to the substrate using a process comprising a member selected from the group consisting of gravure coating, knife over roll coating, Meyer Rod coating, curtain coating, air knife coating, roll coating, reverse angle doctor blade coating, comma roll, lip coating, screen printing, spray coating, and extrusion coating.

27. The process according to claim 3, further comprising heating the additive delivery slurry to dissolve the thermoplastic polymer in the organic solvent.

28. A process for imparting color, fragrance, and/or flavor to a food product, comprising:
(A) preparing an additive delivery laminate by:
(i) providing an additive delivery slurry comprising an organic solvent, a water-insoluble thermoplastic polymer dissolved in the organic solvent, and additive granules dispersed in the organic solvent, the additive granules comprising at least one member selected from the group consisting of colorant, flavorant, and odorant;
(ii) applying a coating of the additive delivery slurry onto a substrate; and
(iii) evaporating the organic solvent from the additive delivery slurry to form an additive delivery coating on the substrate;
(B) converting the additive delivery laminate into a packaging article so that the additive delivery coating is present on the inside surface of the packaging article;
(C) packaging a food product in the packaging article; and
(D) heating the food package so that the colorant and/or flavorant and/or odorant are transferred to the food product.

29. A process for preparing a cooked food product, comprising:
(A) packaging a food product in a packaging article comprising a laminate which is adhered to itself or another component of the packaging article, wherein the laminate comprises:
(1) a substrate layer; and
(2) an additive delivery layer comprising:
(i) a thermoplastic polymer, and
(ii) water-soluble granules comprising at least one member selected from the group consisting of colorant, flavorant, and odorant; and
wherein the water-soluble granules form at least a portion of a surface of the additive layer which is opposite the substrate layer.
(B) heating the packaged food product to a temperature of from 45° C. to 200°, so that at least a portion of the additive is delivered to the food product.

30. A process for preparing a cooked food product, comprising:
(A) packaging a food product in a packaging article comprising a laminate which is adhered to itself or another component of the packaging article, wherein the laminate comprises:
(1) a substrate layer; and
(2) an additive delivery layer comprising:
(i) a thermoplastic polymer, and
(ii) additive granules comprising at least one member selected from the group consisting of colorant, flavorant, and odorant; and
(iii) a hydrogenated rosin; and
wherein the additive granules form at least a portion of a surface of the additive layer which is opposite the substrate layer.
(B) heating the packaged food product to a temperature of from 45 C to 200 C, so that at least a portion of the additive transfers to the food product.

31. The process according to claim 30, wherein the food product is uncooked when packaged, with the packaged food product thereafter being heated to a temperature of from about 62° C. to about 77° C. for a period of from about 3 hours to about 10 hours, so that the additive transfers to the food product while the food product is being cooked.

32. The process according to claim 31, wherein the food product is cooked when packaged, with the packaged food product thereafter being heated to a temperature of from about 71° C. to about 99° C. for a period of from about 3 minutes to about 30 minutes, so that the additive transfers to the food product.
